(19) United States
(12) Patent Application Publication
(10) Pub. No.: US 2025/0105975 A1
(43) Pub. Date: Mar. 27, 2025

(54) METHOD AND DEVICE FOR POSITIONING VIA A SIDELINK IN WIRELESS COMMUNICATION SYSTEM

(71) Applicant: Samsung Electronics Co., Ltd., Gyeonggi-do (KR)

(72) Inventors: Youngbum KIM, Gyeonggi-do (KR); Cheolkyu SHIN, Gyeonggi-do (KR); Heedon GHA, Gyeonggi-do (KR); Taehan BAE, Gyeonggi-do (KR)

(21) Appl. No.: 18/883,311

(22) Filed: Sep. 12, 2024

(30) Foreign Application Priority Data
Sep. 27, 2023 (KR) 10-2023-0130683

(51) Int. Cl. H04L 5/00; H04W 72/25

(52) U.S. Cl. CPC H04L 5/0051; H04W 72/25

(57) ABSTRACT

The disclosure relates to a 5G or 6G communication system for supporting a higher data transmission rate. A user equipment (UE) includes transceiver, and a controller coupled to the transceiver, and configured to receive, from a base station, first information configuring sidelink positioning reference signal (SL PRS) resources in a shared resource pool, receive, from the base station, second information configuring phase tracking reference signal (PTRS) resources, and transmit, to the base station, a PTRS on a PTRS resource which is not overlapped with an SL PRS resource, wherein the shared resource pool is for the SL PRS resources and physical sidelink shared channel (PSSCH) resources.

### CROSS-REFERENCE TO RELATED APPLICATION(S)

This application is based on and claims priority under 35 U.S.C. § 119 to Korean Patent Application No. 10-2023-0130683, which was filed in the Korean Intellectual Property Office on Sep. 27, 2023, the entire disclosure of which is incorporated herein by reference.

### BACKGROUND

### 1. Field

The disclosure relates generally to a wireless communication system and, more particularly, to a method and a device for performing positioning (e.g., location measurement) via a sidelink (SL).

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement 6G mobile communication technologies (referred to as Beyond 5G systems) in terahertz (THz) bands (for example, 95 GHz to 3 THz bands) to accomplish transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying two-step random access channel (2-step RACH) for NR procedures. There also has been ongoing standardization in system architecture/service regarding a 5G service based architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

To meet the demand for wireless data traffic having increased since deployment of 4G communication systems, efforts have been made to develop an improved 5G communication system (e.g., NR). The 5G communication system has been designed to support ultrahigh frequency (mm Wave) bands (e.g., 28 GHz frequency bands) so as to achieve higher data rates. To decrease the propagation loss of the radio waves and increase the transmission distance of radio waves in the ultrahigh frequency (mmWave) bands, beamforming, massive multiple-input multiple-output (massive MIMO), full dimensional MIMO (FD-MIMO), array antenna, an analog beamforming, and large scale antenna techniques have been discussed in the 5G communication system. Also, unlike in LTE, in the 5G communication systems, various subcarrier spacings including 15 kHz, 30 kHz, 60 kHz, and 120 kHz are supported, physical control channels use polar coding, and physical data channels use an LDPC. Furthermore, as waveforms for uplink (UL) transmission, a cyclic prefix-orthogonal frequency division multiplexing (CP-OFDM) as well as a discrete Fourier transform-spread-orthogonal frequency division multiplexing (DFT-S-OFDM) are used. While hybrid automatic repeat request (HARQ) retransmission in units of transport blocks (TBs) are supported in LTE, HARQ retransmission based on a code block group (CBG) including a bundle of a plurality of code blocks (CBs) may be additionally supported in 5G.

In the 5G communication system, technical development for system network improvement is under way based on evolved small cells, advanced small cells, cloud radio access networks (RANs), ultra-dense networks, device-to-device (D2D) communication, wireless backhaul, moving network, cooperative communication, coordinated multi-points (CoMPs), reception-end interference cancellation, and the like.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as sensing technology, wired/wireless communication and network infrastructure, service interface technology, and security technology have been demanded for IoT implementation, a sensor network, a machine-to-machine (M2M) communication, machine type communication (MTC), and so forth have recently been researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

Thus, various attempts have been made to apply the 5G communication system to IoT networks. For example, technologies such as a sensor network, MTC, and M2M communication are implemented by beamforming, MIMO, and array antenna techniques that are 5G communication technologies. Application of a cloud RAN as the above-described big data processing technology may also be considered an example of convergence of the 5G technology with the IoT technology.

As demands for mobile services are explosively increasing, a location-based service (LBS) led by two requirements including an emergency service and a commercial application is rapidly developing. In communication using SL, an NR SL system supports UE-to-UE unicast communication, groupcast (or multicast) communication, and broadcast communication. Unlike LTE SL, which aims to transmit and receive basic safety information necessary for road driving of vehicles, the NR SL aims to provide more advanced services such as platooning, advanced driving, extended sensors, and remote driving.

Positioning (e.g., location measurement) may be performed via an SL between UEs in an NR SL. For example, a method of measuring a location of a UE by using a positioning signal transmitted via an SL may be considered. A positioning method considered in an SL may include at least one of an SL round trip time (RTT), an SL reference signal time difference (SL-RSTD), an SL relative time of arrival (RTOA), or an SL angle of arrival (AoA). A coordinate location of a UE or a distance between UEs may be calculated via corresponding measurement.

An existing method of measuring a location of a UE by using a positioning signal transmitted via a downlink (DL) and a UL between the UE and a base station is possible only when the UE is within coverage of the base station. However, when SL positioning is adopted, a location of a UE may be measured even when the UE is outside coverage of a base station. In this case, a positioning signal in an SL may be referred to as an SL positioning reference signal (PRS).

An SL PRS may be transmitted in a resource pool (e.g., may be referred to as shared resource pool with SL communication) where SL communication (e.g., data transmission) is performed. An SL PRS may be transmitted in a resource pool (e.g., may be referred to as dedicated resource pool for SL positioning) defined for SL PRS transmission.

There is a need in the art for a method for resolving collision between an SL PRS and other reference signals when the SL PRS is transmitted in a resource pool where SL communication (e.g., data transmission) is performed. The other reference signals may include an SL phase tracking reference signal (SL PTRS) or an SL channel state information reference signal (SL CSI-RS). There is a need in the art for a collision avoidance method whereby simultaneous transmission of a positioning signal and other reference signals and reception performance of reference signals may be improved.

### SUMMARY

The disclosure has been made to address at least the above-mentioned problems and/or disadvantages and to provide at least the advantages described below.

Accordingly, an aspect of the disclosure is to provide an electronic device and a method capable of effectively providing services in a wireless communication system.

An aspect of the disclosure is to a method and a procedure for performing positioning (location measurement) by a UE whereby positioning can be performed more effectively than in the conventional art.

In accordance with an aspect of the disclosure, a UE in a wireless communication system includes a transceiver, and a controller coupled to the transceiver, and configured to receive, from a base station, first information configuring sidelink positioning reference signal (SL PRS) resources in a shared resource pool, receive, from the base station, second information configuring phase tracking reference signal (PTRS) resources, and transmit, to the base station, a PTRS on a PTRS resource which is not overlapped with an SL PRS resource, wherein the shared resource pool is for the SL PRS resources and physical sidelink shared channel (PSSCH) resources.

In accordance with an aspect of the disclosure, a base station in a wireless communication system includes a transceiver; and a controller coupled to the transceiver, and configured to transmit, to a user equipment, UE, first information configuring sidelink positioning reference signal (SL PRS) resources in a shared resource pool, transmit, to the UE, second information configuring phase tracking reference signal (PTRS) resources, and receive, from the UE, a PTRS on a PTRS resource which is not overlapped with an SL PRS resource, wherein the shared resource pool is for the SL PRS resources and physical sidelink shared channel (PSSCH) resources.

In accordance with an aspect of the disclosure, a method of a UE in a wireless communication system includes receiving, from a base station, first information configuring sidelink positioning reference signal (SL PRS) resources in a shared resource pool, receiving, from the base station, second information configuring phase tracking reference signal (PTRS) resources, and transmitting, to the base station, a PTRS on a PTRS resource which is not overlapped with an SL PRS resource, wherein the shared resource pool is for the SL PRS resources and physical sidelink shared channel (PSSCH) resources.

In accordance with an aspect of the disclosure, a method of a base station in a wireless communication system includes transmitting, to a user equipment, UE, first information configuring sidelink positioning reference signal (SL PRS) resources in a shared resource pool, transmitting, to the UE, second information configuring phase tracking reference signal (PTRS) resources, and receiving, from the UE, a PTRS on a PTRS resource which is not overlapped with an SL PRS resource, wherein the shared resource pool is for the SL PRS resources and physical sidelink shared channel (PSSCH) resources.

### BRIEF DESCRIPTION OF THE DRAWINGS

The above and other aspects, features, and advantages of the disclosure will be more apparent from the following detailed description taken in conjunction with the accompanying drawings, in which:

FIG. 1A illustrates a case (e.g., in-coverage (IC)) in which both UEs (UE-1 and UE-2) communicating via an SL are located within coverage of a base station according to an embodiment;

FIG. 1B illustrates when UE-1 among the UEs is located within coverage of the base station and UE-2 is located outside the coverage of the base station according to an embodiment;

FIG. 1C illustrates a case (e.g., out-of-coverage (OOC)) in which both UEs are located outside the coverage of the base station according to an embodiment;

FIG. 1D illustrates a scenario in which SL communication is performed between the UEs located in different cells according to an embodiment;

FIG. 2A illustrates a communication method performed via an SL according to an embodiment;

FIG. 2B illustrates a communication method performed via an SL according to an embodiment;

FIG. 3 illustrates a resource pool for SL communication according to an embodiment;

FIG. 4 illustrates examples for calculating a location of a UE via an SL according to an embodiment;

FIG. 5 illustrates examples for calculating a location of a UE via an SL according to an embodiment;

FIG. 6 illustrates examples for calculating a location of a UE via an SL according to an embodiment;

FIG. 7 illustrates various examples of SL location measurement according to an embodiment;

FIG. 8A to FIG. 8C illustrate examples of various physical layer structures for SL communication according to an embodiment;

FIG. 9 illustrates an example of a location at which an SL PTRS is transmitted according to an embodiment;

FIG. 10 illustrates an example of a resource for transmitting an SL CSI-RS according to an embodiment;

FIG. 11 illustrates an example of an SL PRS in a resource pool where sidelink communication is performed according to an embodiment;

FIG. 12A illustrates frequency patterns in which an SL PRS is transmitted according to an embodiment;

FIG. 12B illustrates frequency patterns in which an SL PRS is transmitted according to an embodiment;

FIG. 13A illustrates various examples of resources for SL transmission according to an embodiment;

FIG. 13B illustrates various examples of resources for sidelink transmission according to an embodiment;

FIG. 14 illustrates various examples of resources for SL transmission according to an embodiment;

FIG. 15 illustrates a structure of a UE according to an embodiment; and

FIG. 16 illustrates a structure of a base station according to an embodiment.

### DETAILED DESCRIPTION

Embodiments of the disclosure will be described in detail referring to the accompanying drawings. A detailed description of known functions or configurations incorporated herein will be omitted for the sake of clarity and conciseness.

For the same reasons, some elements may be exaggerated or schematically shown. The size of each element does not necessarily reflect the actual size of the element. The same reference numeral may be used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto.

Throughout the specification, the same or like reference signs indicate the same or like elements.

As used herein, the unit refers to a software element or a hardware element, such as a field programmable gate array (FPGA) or an application specific integrated circuit (ASIC), which performs a predetermined function. However, the unit does not always have a meaning limited to software or hardware. The unit may be constructed either to be stored in an addressable storage medium or to execute one or more processors. Therefore, the unit includes software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more CPUs within a device or a security multimedia card. Furthermore, the unit in embodiments may include one or more processors.

The disclosure is generally directed to the NR radio access network (RAN) and packet core (5G system or 5G core network or next generation core (NG Core)) as a core network in the 5G mobile communication standards specified by the 3rd generation partnership project (3GPP) that is a mobile communication standardization group. Based on determinations by those skilled in the art, however, the disclosure may be applied to other communication systems having similar backgrounds through some modifications without significantly departing from the scope of the disclosure.

Herein, some of terms and names defined in the 3GPP standards (standards for 5G, NR, LTE, or similar systems) may be used for the sake of descriptive convenience. However, the disclosure is not limited by these terms and names, and may be applied in the same manner to systems that conform other standards.

Terms for identifying access nodes and referring to network entities, messages, interfaces between network entities, and various identification information, are illustratively used for the sake of descriptive convenience. Therefore, the disclosure is not limited by the terms as used herein, and other terms referring to subjects having equivalent technical meanings may be used.

Herein, a UE may include a general UE and a UE supporting V2X. A UE may include at least one of a handset (e.g., a smartphone) of a pedestrian, a vehicle supporting vehicular-to-vehicular (V2V) communication, a vehicle supporting vehicular-to-pedestrian (V2P) communication, a vehicle supporting vehicular-to-network (V2N) communication, or a vehicle supporting vehicular-to-infrastructure (V2I) communication. In addition, in the disclosure, a UE may include at least one of a road side unit (RSU) equipped with UE functions, an RSU equipped with base station functions, or an RSU equipped with some of base station functions and some of UE functions.

In addition, a base station may be a base station supporting both V2X communication and general cellular communication, or a base station supporting only V2X communication. In this case, a base station may include at least one of a 5G base station (e.g., gNB), a 4G base station (e.g., eNB), or an RSU. Accordingly, a base station may be referred to as an RSU.

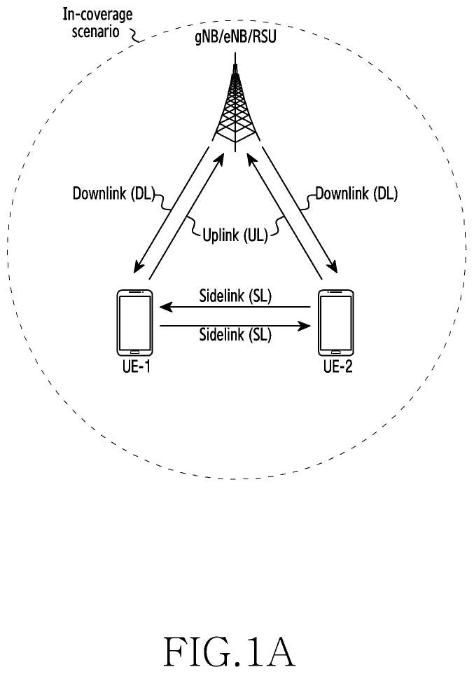

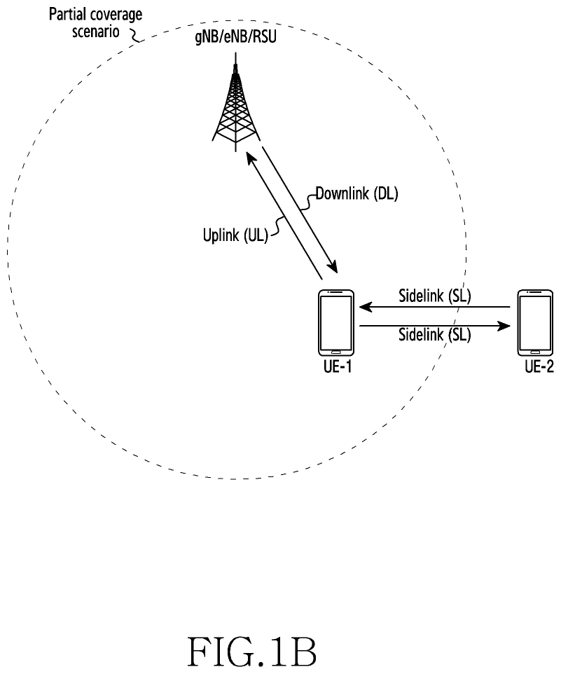

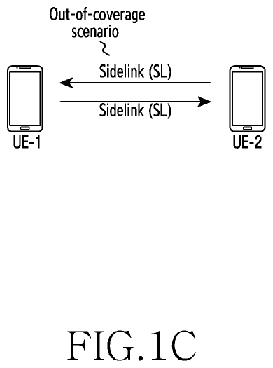

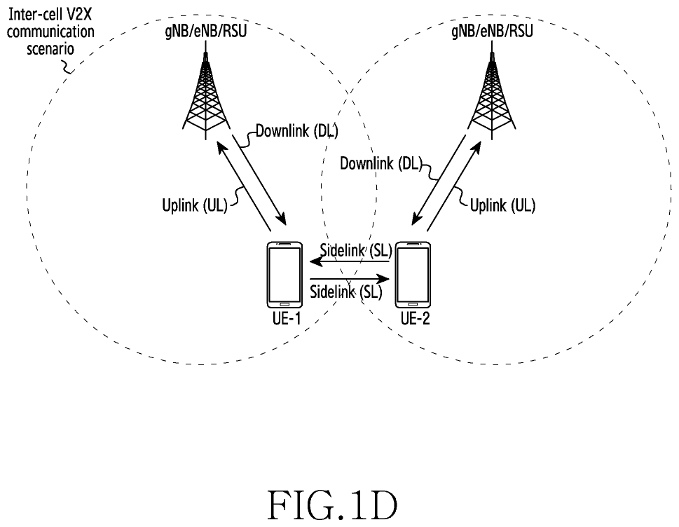

FIG. 1A illustrates a case (e.g., IC) in which both UEs (UE-1 and UE-2) communicating via an SL are located within coverage of a base station according to an embodiment.

Referring to FIG. 1A, both the UEs may receive data and control information from a base station via DL, or transmit data and control information to the base station via a UL. In this case, the data and control information may include data and control information for SL communication. The data and control information may also include data and control information for general cellular communication. In addition, the UEs may transmit and receive data and control information for corresponding communication via SL.

FIG. 1B illustrates when UE-1 among the UEs is located within coverage of the base station and UE-2 is located outside the coverage of the base station according to an embodiment. Referring to FIG. 1B, partial coverage (e.g., PC) in which a part (UE-2) of the UEs is located outside the coverage of the base station is shown. UE-1 located within the coverage of the base station may receive data and control information from the base station via a DL or transmit data and control information to the base station via a UL. UE-2 located outside the coverage of the base station cannot receive data and control information from the base station via a DL and cannot transmit data and control information to the base station via a UL. UE-2 may transmit and receive data and control information for corresponding communication to and from UE-1 via an SL.

FIG. 1C illustrates a case (e.g., OOC) in which both UEs are located outside the coverage of the base station according to an embodiment. Referring to FIG. 1C, UE-1 and UE-2 cannot receive data and control information from the base station via a DL and cannot transmit data and control information to the base station via a UL. (UE-1 and UE-2 may transmit and receive data and control information via an SL.

FIG. 1D illustrates a scenario in which SL communication is performed between UE-1 and UE-2 located in different cells according to an embodiment.

Referring to FIG. 1D, UE-1 and UE-2 are connected to (e.g., radio resource control (RRC) connected state) or camp on (e.g., RRC disconnected state, i.e., RRC idle state) different base stations. In this case, UE-1 may be a transmission UE and UE-2 may be a reception UE in the SL. Alternatively, UE-1 may be a reception UE and the UE-2 may be a transmission UE in the SL. The UE (UE-1) may receive a system information block (SIB) from a base station to which UE-1 is connected (or on which UE-1 is camping), and UE-2 may receive an SIB from another base station to which UE-2 is connected (or on which UE-2 is camping). In this case, the SIB may use an existing SIB or may include an SIB defined separately for SL communication. In addition, information of the SIB received by UE-1 and information of the SIB received by UE-2 may be the same or different from each other. Therefore, to perform SL communication between UE-1 and UE-2 located in different cells, the information described above may need to be unified, or after information on the SL communication is signaled, a method for interpreting the SIB information transmitted from respective different cells may be additionally required.

FIGS. 1A-1D illustrate an SL system including two UEs (UE-1 and UE-2) for convenience of description. However, the disclosure is not limited thereto, and communication may be performed between more UEs according to an embodiment. In addition, an interface (e.g., UL and DL) between the base station and the UEs may be referred to as a Uu interface, and SL communication between the UEs may be referred to as a PC5 interface.

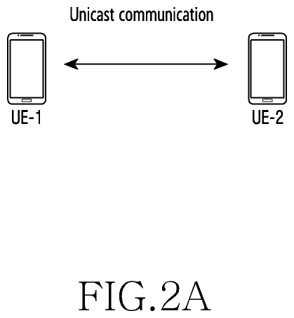

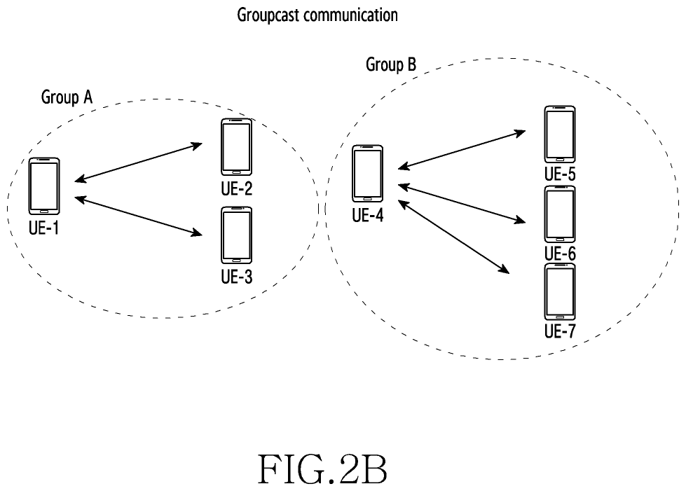

FIG. 2A illustrates a communication method performed via an SL according to an embodiment.

Referring to FIG. 2A, UE-1 (e.g., TX UE) and UE-2 (e.g., RX UE) may perform one-to-one communication which may be referred to as unicast communication. Capability information and configuration information may be exchanged between the UEs via PC5-RRC defined in a unicast link between the UEs in an SL. In addition, configuration information may be exchanged via an SL medium access control (MAC) control element (CE) defined in the unicast link between the UEs. The configuration information may include destination ID and source ID information.

However, an information exchange method for unicast is not limited to the PC5-RRC and MAC-CE described above. The related information described above may be included in side control information (SCI). The SCI may include 1st SCI or 2nd SCI. In addition, some of the information may be included in the SCI, and the remaining part may be included in another channel and transmitted via PC5-RRC or MAC-CE.

Referring to FIG. 2B, the TX UE and the RX UE may perform one-to-many communication which may be referred to as groupcast or multicast. In (b) of FIG. 2, UE-1, UE-2, and UE-3 may form one group (group A) to perform groupcast communication, and UE-4, UE-5, UE-6, and UE-7 may form another group (group B) to perform groupcast communication. Each UE may perform groupcast communication only within a group to which each UE belongs, and communication between different groups may be performed via unicast, groupcast, or broadcast communication. In FIG. 2B, two groups (group A and group B) are formed, but of course, the disclosed is not limited thereto.

The UEs may perform broadcast communication in an SL. Broadcast communication may refer to when data and control information transmitted by a transmission UE via an SL may be received by all other UEs. For example, in FIG. 2B, when it is assumed that UE-1 is a transmission UE for broadcast, all UEs (UE-2, UE-3, UE-4, UE-5, UE-6, and UE-7) may receive data and control information transmitted by UE-1.

In NR V2X, unlike in LTE V2X, support of a form in which a vehicle UE transmits data to only one specific node via unicast and a form in which data is transmitted to specific multiple nodes via groupcast may be considered. For example, these unicast and groupcast technologies may be useful in a service scenario, such as platooning that is a technology of connecting two or more vehicles via a single network and moving the vehicles in a group form. Specifically, unicast communication may be required for the purpose of controlling one specific node by a leader node of a group connected by platooning, and groupcast communication may be required for the purpose of simultaneously controlling a group including specific multiple nodes.

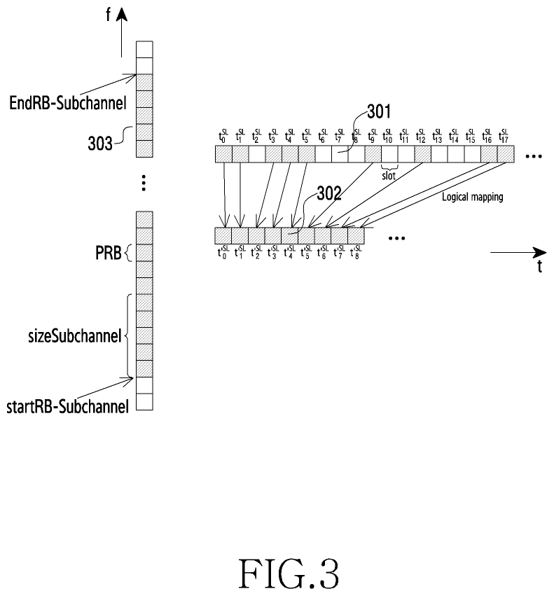

FIG. 3 illustrates a resource pool for SL communication according to an embodiment. Referring to FIG. 3, a resource pool is defined as a set of resources in time and frequency used for SL transmission and reception.

A resource granularity of the time axis in the resource pool may include a slot. In addition, a resource granularity of the frequency axis may include a sub-channel including one or more physical resource blocks (PRBs). The disclosure describes when a resource pool is allocated non-consecutively in time, but it is obvious that when a resource pool is allocated consecutively in time may also be included. In addition, the disclosure describes when a resource pool is allocated consecutively in frequency, but it is obvious that a method in which a resource pool is allocated non-consecutively in frequency is not excluded.

Referring to FIG. 3, case 301 illustrates when a resource pool is non-consecutively allocated in time. Referring to FIG. 3, the granularity of resource allocation in time may include a slot.

An SL slot may be defined within a slot used for a UL. Specifically, within one slot, a length of a symbol used for an SL may be configured via SL bandwidth part (BWP) information. Therefore, among slots used for a UL, slots in which a symbol length configured for an SL is not guaranteed may not be SL slots. In addition, slots in which an SL synchronization signal block (S-SSB) is transmitted may be excluded from slots belonging to the resource pool.

In case 301 of FIG. 3, a set of slots available for an SL in time, excluding the slots described above, is illustrated as (tₙ^{SL}, t₁^{SL}, t₂^{SL} . . . ). Shaded parts in case 301 may represent SL slots belonging to the resource pool. The SL slots belonging to the resource pool may be (pre-) configured with resource pool information via a bitmap.

In case 302 of FIG. 3, a set of SL slots belonging to the resource pool in time is illustrated as (t′ₙ^{SL}, t′₁^{SL}, t′₂^{SL} . . . ). A (pre-) configuration may indicate configuration information that is pre-configured for and pre-stored in a UE, or may indicate configuration information that is configured in a cell-common manner from a base station. Cell-common may indicate that UEs within a cell receive the same information configuration from a base station. In this case, the UEs may receive an SL-SIB from the base station to acquire cell-common information.

The (pre-) configuration may also indicate when a UE is configured in a UE-specific manner after establishing an RRC connection with a base station. UE-specific may be replaced with the term UE-dedicated, and may indicate that each UE receives configuration information with a specific value. In this case, the UE may receive an RRC message from the base station to acquire UE-specific information.

A method of (pre-) configuration with resource pool information and a method of no (pre-) configuration in resource pool information may also be considered. (Pre-) configuration with resource pool information may include when, except for a UE configured in a UE-specific manner after establishment of an RRC connection with the base station, all UEs operating in a corresponding resource pool may be configured via common configuration information.

The method of no (pre-) configuration in resource pool information may include a method of performing configuration independently of resource pool configuration information. For example, (pre-) configuration may be performed with SL BWP information and applied equally to the entire resource pool. In another example, one or more modes (e.g., A, B, and C) may be (pre-) configured in the resource pool, and information (pre-) configured independently of the resource pool configuration information may indicate a mode to be used (e.g., A, B, or C) from among the modes (pre-) configured in the resource pool.

In SL unicast transmission, (pre-) configuration may also be configured via PC5-RRC. Alternatively, a method of (pre-) configuration via MAC-CE may also be considered. According to various embodiments of the disclosure, (pre-) configuration in the disclosure may, of course, indicate that all the cases described above are applicable.

In case 303 in FIG. 3, when a resource pool is allocated consecutively in frequency is illustrated. On the frequency axis, resource allocation may be configured with SL BWP information and may be performed in units of sub-channels. A sub-channel may be defined as a resource granularity in frequency, which includes one or more PRBs. For example, a sub-channel may be defined to have an integer multiple of a PRB.

In case 303, a sub-channel may include five consecutive PRBs, and a sub-channel size (sizeSubchannel) may be a size of five consecutive PRBs. However, The content illustrated in FIG. 3 is merely an example of the disclosure, and a size of a sub-channel may be configured differently. It is common that one sub-channel includes consecutive PRBs, but it is obvious that one sub-channel may not necessarily include consecutive PRBs.

A sub-channel may be a basic resource granularity for a PSSCH. In case 303, startRB-Subchannel may indicate a start position of the sub-channel in frequency in the resource pool.

When resource allocation is performed in units of sub-channels on the frequency axis, resources in frequency may be allocated via configuration information on a resource block (RB) index (startRB-Subchannel) where the sub-channel starts, information (sizeSubchannel) on the number of PRBs constituting the sub-channel, the total number (numSubchannel) of sub-channels, or the like. In this case, information on startRB-Subchannel, sizeSubchannel, and numSubchannel may be (pre-) configured as resource pool information in frequency.

A method for allocating transmission resources in an SL may include a method of SL transmission resource allocation from a base station when a UE is within coverage of a base station, which will be referred to herein as mode 1. For example, mode 1 may indicate a method in which a base station allocates resources used for SL transmission to RRC-connected UEs via a dedicated scheduling scheme. The method of mode 1 may be effective for interference management and resource pool management because a base station is able to manage SL resources.

In contrast, the methods of allocating transmission resources in an SL may include a method in which a UE allocates transmission resources via direct sensing in an SL, which will be referred to herein as mode 2. Mode 2 may also be referred to as UE autonomous resource selection. Unlike mode 1 in which a base station directly participates in resource allocation, mode 2 allows a transmission UE to autonomously select resources via a sensing and resource selection procedure defined based on a (pre-) configured resource pool, and transmit data via the selected resources.

When transmission resources are allocated via mode 1 or mode 2, the UE may transmit and receive data and control information via an SL. The control information may include SCI format 1-A as 1st stage SL control information (SCI) transmitted via a physical SL control channel (PSCCH). In addition, the control information may include at least one of SCI format 2-A or SCI format 2-B as 2nd stage SCI transmitted via the PSSCH.

Hereinafter, for positioning (e.g., location measurement) of measuring a location of a UE, a method using positioning signals (e.g., positioning reference signals (PRSs)) transmitted via a DL and a UL between a UE and a base station is described.

The method using positioning signals transmitted via a DL and a UL between a UE and a base station in the disclosure may be referred to as radio access technology (RAT)-dependent positioning. In addition, other positioning methods may be referred to as RAT-independent positioning.

Specifically, for the LTE system, an RAT-dependent positioning technique may include methods, such as observed time difference of arrival (OTDOA), UL time difference of arrival (UTDOA), or enhanced cell identification (E-CID). For the NR system, methods, such as a DL time difference of arrival (DL-TDOA), a DL angle-of-departure (DL-AOD), multi-RTT, NR E-CID, a UL-TDOA, or a UL angle-of-arrival (UL-AOA), may be included. In contrast, an RAT-independent positioning technique may include methods, such as assisted global navigation satellite systems (A-GNSS), sensor, wireless local area network (WLAN), or Bluetooth.

In the disclosure, a RAT-dependent positioning method supported mainly via an SL is specifically described. For an interface (e.g., UL and DL, hereinafter, referred to as Uu) between a base station and UEs, RAT-dependent positioning may be possible only when a UE is within coverage of the base station. However, RAT-dependent positioning of an SL may not be limited to when a UE is within coverage of a base station.

For RAT-dependent positioning in Uu, a positioning protocol, such as an LTE positioning protocol (LPP), an LTE positioning protocol annex (LPPa) or an NR positioning protocol annex (NRPPa), may be used. The LPP may be considered as a positioning protocol defined between a UE and a location server (LS), and the LPPa or NRPPa may be considered as a protocol defined between a base station and the LS. The LS manages location measurement, and may perform functions of a location management function (LMF). In addition, the LS may also be referred to as LMF or another name. For LTE and NR systems, both systems may support LPP, and at least one of positioning capability exchange, assistance data transmission, location information transmission, error processing, and aborting for positioning may be performed via LPP.

When a UE and an LS perform the aforementioned roles via the LPP, a base station may serve as a mediator for the UE and the LS to exchange positioning information. In this case, exchanging of the positioning information via the LPP may be performed transparently to the base station which may indicate that the base station is not involved in exchanging of the positioning information between the UE and the LS.

For exchanging of positioning capability, the UE may exchange supportable positioning information with the LS. For example, the positioning information supportable by the UE may include information on at least one of whether a positioning method supported by the UE is UE-assisted or UE-based, or whether both are possible.

In a UE-assisted case, the UE may not directly measure an absolute position of the UE, and based on a received positioning signal, may transfer a measurement value for the positioning technique to the LS. The absolute position of the UE may be calculated by the LS. The absolute position may represent two-dimensional (x, y) and three-dimensional (x, y, z) coordinate location information of the UE according to longitude and latitude.

In contrast, a UE-based case may be a scheme in which the UE directly measures an absolute position of the UE. To this end, while receiving a positioning signal, the UE also needs to receive location information of a subject which transmits the positioning signal.

While only the UE-assisted scheme is supported in the LTE system, positioning based on both the UE-assisted and UE-based schemes may be supported in the NR system.

When measuring an accurate location of the UE, transmission of assistance data may be a very important element in positioning. Specifically, the assistance data may include configuration information on a positioning signal transmitted to the UE by the LS, candidate cell and transmission reception point (TRP) information for reception of the positioning signal, etc. Specifically, when DL-TDOA is used, the candidate cell and TRP information for reception of the positioning signal may include information on at least one of a reference cell, a reference TRP, a neighbor cell, or a neighbor TRP. In addition, when multiple candidates for the neighbor cell or neighbor TRP are provided, the assistance data may also include information on which cell and TRP is desirable for the UE to select to measure the positioning signal.

For the UE to measure an accurate location, it is required to properly select candidate cell and TRP information serving as references. For example, when a channel for a positioning signal received by the UE from a corresponding candidate cell and TRP is a line-of-site (LOS) channel (e.g., as the channel has fewer non-LOS (NLOS) channel components), the accuracy of positioning measurement may be increased. Therefore, when the LS provides the UE with candidate cell and TRP information, which serve as references for performing positioning, via more diverse information collection, the UE may perform more accurate positioning measurement.

Location information transmission may be performed via the LPP. The LS may request location information from the UE, and the UE may provide the LS with the measured location information in response to the request.

For the UE-assisted case, the location information may include a measurement value for the positioning technique based on the positioning signal.

In contrast, for a UE-based case, the location information may include two-dimensional (x, y) and three-dimensional (x, y, z) coordinate location values of the UE.

When requesting the location information from the UE, the LS may make the request including a required response time, accuracy, etc. as positioning quality of service (QOS) information. When the positioning QoS information is requested, the UE needs to provide the LS with the location information measured to meet the accuracy and response time. If it is impossible to satisfy the QoS, the UE may consider error processing and aborting. However, this is merely an example, and error processing and aborting of positioning may be performed in other cases.

The positioning protocol defined between the base station and the LS may be referred to as LPPa in the LTE system, and at least one of E-CID location information transmission, OTDOA information transmission, general error state reporting, and assistance information transmission may be performed between the base station and the LS.

The positioning protocol defined between the base station and the LS may be referred to as NRPPa in the NR system. At least one of positioning information transmission, measurement information transmission, and TRP information transmission may be performed between the base station and the LS.

Unlike the LTE system, more positioning techniques may be supported in the NR system. Therefore, various positioning techniques via the aforementioned positioning information transmission may be supported. For example, via a positioning sounding reference signal (SRS) transmitted by the UE, the base station may perform positioning measurement. Therefore, as positioning information, positioning SRS configuration and activation/deactivation-related information may be exchanged between the base station and the LS.

The measurement information transmission may refer to exchanging information related to multi-RTT, UL-TDOA, and UL-AOA between the base station and the LS, the function not being supported in the LTE system. For the TRP information transmission, cell-based positioning has been performed in the LTE system. However, in the NR system, TRP-based positioning may be performed, so that information related to performing positioning based on a TRP between the UE and the base station or the LS may be exchanged.

A subject performing positioning-related configuration to measure a location of the UE in an SL and a subject calculating positioning may be divided into UE (no LS), LS (through BS), and

LS (through UE).

The LS described above may refer to an LS, the base station (BS) may refer to a base station, such as gNB or eNB, and the UE may refer to a terminal performing transmission/reception via an SL. As described above, the UE performing transmission/reception via an SL may include a vehicle UE and a pedestrian UE. In addition, the UE performing transmission/reception via an SL may include an RSU equipped with UE functions, an RSU equipped with base station functions, or an RSU equipped with some of the base station functions and some of the UE functions. In addition, the UE performing transmission/reception via an SL may include a positioning reference unit (PRU) having an unknown position.

The UE (no LS) may refer to an SL UE without a connection to a LS.

The LS (through BS) is a location server and may refer to a location server connected to a base station.

The LS (through UE) is an LS and may refer to a location connected to an SL UE. For example, the LS (through UE) may indicate when an LS is available even when a UE is not within coverage of a base station.

In this case, the LS (through UE) may be available only to a specific UE, such as an RSU or PRU, which is not a general UE. A UE connected to an LS in an SL may be defined as a new type of device (UE). Only a specific UE supporting a UE capability of connecting to an LS may perform a function of connecting to an LS via an SL.

In Table 1 below, cases 1 to 9 represent various combinations according to a subject performing positioning-related configuration and a subject calculating positioning to measure a location of a UE in an SL.

A UE requiring location measurement of the UE may be referred to as a target UE. In addition, a UE which has a known location thereof or is able to provide a positioning signal for location measurement of a target UE may be referred to as an anchor UE. Therefore, an anchor UE may have its own location information and may also provide UE location information via an SL positioning reference signal (SL PRS).

An anchor UE may be a UE, a location of which is already known (known location). However, an anchor UE may be a UE, a location of which is unknown (unknown location).

If an anchor UE has its location that is already known (known location), corresponding location information may be transferred to a target UE, and the target UE may perform UE-based positioning.

According to various embodiments, names of a target UE and an anchor UE may, of course, be replaced with other terms. For example, an anchor UE may be referred to as a positioning reference (PosRef) UE.

The positioning configuration may be classified into a UE-configured scheme and a network-configured scheme. Referring to Table 1, the positioning configuration of UE (no LS) may correspond to the UE-configured scheme. The UE-configured scheme is advantageous that positioning configuration is possible even when a UE is not within the coverage of the network (base station).

In Table 1, the positioning configuration of the LS (through BS) may correspond to the network-configured scheme. The network-configured scheme indicates when a UE is within network coverage, and since positioning calculation and measurement information is reported to the base station, and location measurement of a target UE is performed by the LS connected to the base station, a delay may occur due to signaling related to the location measurement, but more accurate location measurement may be possible.

Since the positioning configuration of the LS (through UE) is not a scheme in which a UE is configured via the base station within the network coverage, the positioning configuration may not be classified as the network-configured scheme. In addition, an LS connected to the UE may provide a configuration, but if the configuration is not classified as being based on the UE, the configuration may not be classified as the UE-configured scheme. However, if the configuration is classified as being based on the UE, the configuration may be classified as the UE-configured scheme. Therefore, the LS (through UE) case may include a different scheme than the UE-configured or network-configured scheme.

Positioning calculation may be classified into two schemes which are UE-assisted and UE-based scheme as described above. In Table 1, the positioning calculation of the UE (no LS) may correspond to the UE-based scheme, or the positioning calculation of the LS (through BS) or LS (through UE) may generally correspond to the UE-assisted scheme. However, for the position calculation of the LS (through UE), if a corresponding LS is interpreted as a UE, the LS (through UE) may also be classified as the UE-based scheme.

TABLE 1

| | Positioning Configuration | Positioning Measurement |
|---|---|---|
| Case 1 | UE (no LS) | UE (no LS) |
| Case 2 | UE (no LS) | LS (through BS) |
| Case 3 | UE (no LS) | LS (through UE) |
| Case 4 | LS (through BS) | UE (no LS) |
| Case 5 | LS (through BS) | LS (through BS) |
| Case 6 | LS (through BS) | LS (through UE) |
| Case 7 | LS (through BS) | UE (no LS) |
| Case 8 | LS (through BS) | LS (through BS) |
| Case 9 | LS (through BS) | LS (through UE) |

In Table 1, positioning configuration information may include SL positioning reference signal (SL PRS) configuration information. The SL PRS configuration information may include information related to a time/frequency transmission location or pattern information of an SL PRS.

For positioning calculation, a UE may receive an SL PRS, and then measurement may be performed from the received SL PRS. A positioning measurement and calculation method may vary according to an applied positioning method. Position information measurement in an SL may include absolute positioning which provides two-dimensional (x, y) and three-dimensional (x, y, z) coordinate position values of a UE, and may include relative positioning which provides relative two-dimensional or three-dimensional position information from another UE. In addition, location information in an SL may include ranging information including at least one of a distance or a direction from another UE. If the meaning of ranging in an SL includes both distance and direction information, the ranging may have the same meaning as relative positioning. Methods such as an SL-TDOA, an SL-AOD, an SL multi-RTT (SL multi-RTT), an SL RTT (SL RTT), SL E-CID, or an SL-AOA, may be considered as positioning methods.

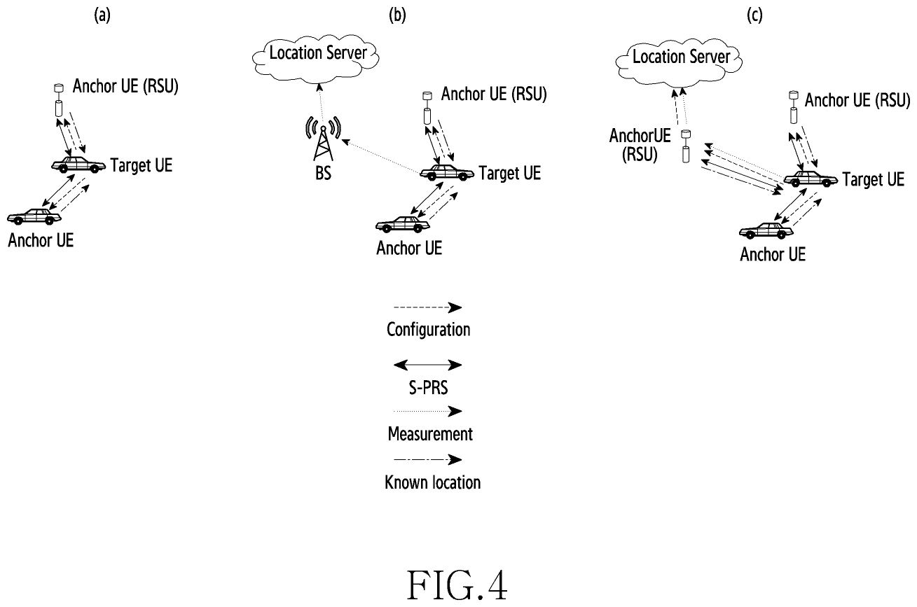

FIGS. 4, 5 and 6 illustrate examples for calculating a location of a UE via an SL according to an embodiment. However, calculation of a UE position via an SL is not limited thereto.

Referring to FIGS. 4, 5 and 6, signaling of positioning configuration information is illustrated by a first dotted line, SL PRS transmission is illustrated by a second dotted line, and for the SL PRS transmission, signaling may be performed in both directions or in one direction. Information measured for positioning or transmission of the measured positioning information is illustrated by a third dotted line, and transmission of location information (e.g., known location) known to a UE is illustrated by a fourth dotted line.

Part (a) of FIG. 4 illustrates an example of when an SL UE without a connection to an LS provides a positioning configuration, and a target UE without a connection to an LS performs positioning calculation. Part (a) of FIG. 4 may correspond to case 1 in Table 1. The target UE may transfer an indication on positioning-related configuration information to another UE, based on broadcast, unicast, or groupcast via an SL. In addition, the target UE may perform positioning calculation based on the received positioning signal.

Part (b) of FIG. 4 illustrates an example of when an SL UE without a connection to an LS that is connected to a base station provides a positioning configuration, a target UE is located within network coverage, and positioning calculation is performed by the LS. Part (b) of FIG. 4 may correspond to case 2 in Table 1. The target UE may transfer an indication on positioning-related configuration information to another UE, based on broadcast, unicast, or groupcast via an SL. In addition, since the target UE performs positioning measurement based on the received positioning signal, and is within base station coverage, the target UE may report the measured positioning information to the base station. Therefore, the measurement information is reported to the LS connected to the base station, and the LS may perform positioning calculation.

Part (c) of FIG. 4 illustrates an example of when an SL UE without a connection to an LS provides a positioning configuration, and via an SL UE connected to the LS, the LS performs positioning calculation. Part (c) of FIG. 4 may correspond to case 3 in Table 1. The target UE may transfer an indication on positioning-related configuration information to another UE, based on broadcast, unicast, or groupcast via an SL. In addition, since the target UE performs positioning measurement based on the received positioning signal, and is within SL coverage of the UE connected to the LS, the target UE may report the measured positioning information to the UE connected to the LS. Part (c) of FIG. 4 illustrates the anchor UE (RSU) as the UE connected to the LS, but the UE connected to the LS may, of course, be a UE other than an RSU. Thereafter, the measurement information is reported to the LS connected to the anchor UE (RSU), and the LS may perform positioning calculation.

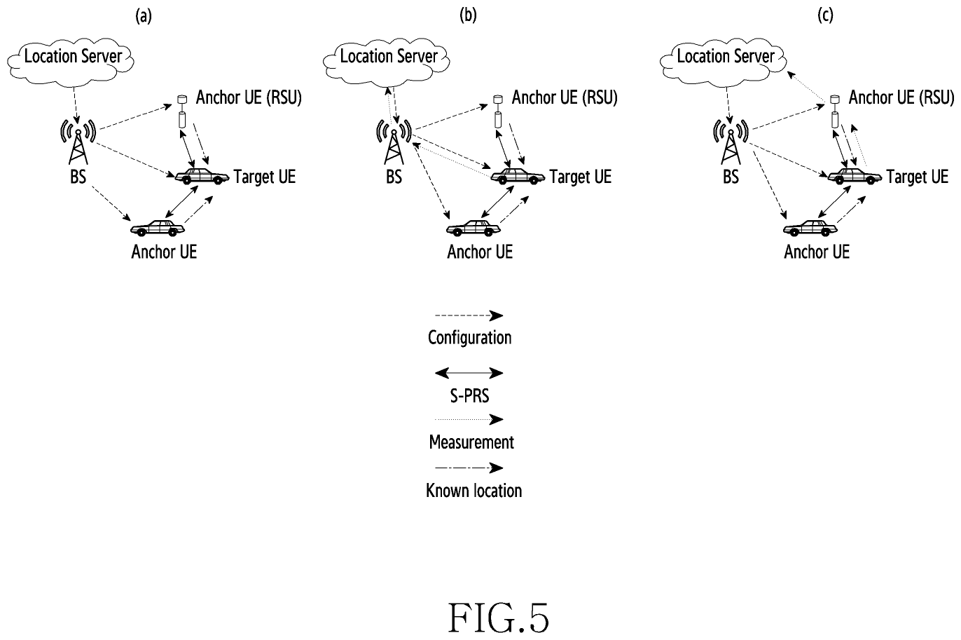

Part (a) of FIG. 5 illustrates when an SL UE is located within network coverage, an LS connected to a base station provides a positioning configuration, and a target UE without a connection to the LS performs positioning calculation. Part (a) of FIG. 5 may correspond to case 4 in Table 1. The LS connected to the base station may provide positioning configuration information by using a positioning protocol, such as LPP. In addition, the target UE may perform positioning calculation based on the received configuration information and positioning signal.

Part (b) of FIG. 5 illustrates when an SL UE is located within network coverage, an LS connected to a base station provides a positioning configuration, a target UE is located within the network coverage, and the LS connected to the base station performs positioning calculation. Part (b) of FIG. 5 may correspond to case 5 in Table 1. The LS connected to the base station may provide positioning configuration information by using a positioning protocol, such as LPP. In addition, since the target UE performs positioning measurement based on the received configuration information and positioning signal, and is within the base station coverage, the measured positioning information may be reported to the base station. Therefore, the measurement information is reported to the LS connected to the base station, and the LS may perform positioning calculation.

Part (c) of FIG. 5 illustrates when an SL UE is located within network coverage, an LS connected to a base station provides a positioning configuration, and via an SL UE connected to the LS, the LS performs positioning calculation. Part (c) of FIG. 5 may correspond to case 6 in Table 1. The LS connected to the base station may provide positioning configuration information by using a positioning protocol, such as LPP. In addition, since the target UE performs positioning measurement based on the received configuration information and positioning signal, and is within SL coverage of the UE connected to the LS, the measured positioning information may be reported to the UE connected to the LS. Part (c) of FIG. 5 illustrates the anchor UE (RSU) as the UE connected to the LS, but the UE connected to the LS may, of course, be a UE other than an RSU. Thereafter, the measurement information is reported to the LS connected to the anchor UE (RSU), and the LS may perform positioning calculation.

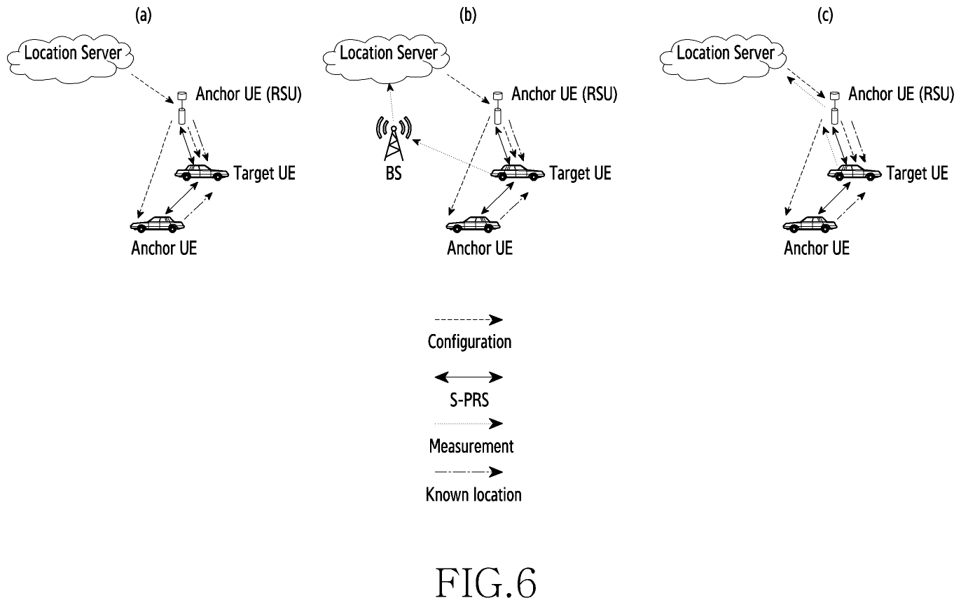

Part (a) of FIG. 6 illustrates when, via an SL UE connected to an LS, the LS provides a positioning configuration, and a target UE without a connection to the LS performs positioning calculation. Part (a) of FIG. 6 may correspond to case 7 in Table 1. The LS connected to the UE may provide positioning configuration information by using a positioning protocol, such as LPP. In addition, the target UE may perform positioning calculation based on the received configuration information and positioning signal.

Part (b) of FIG. 6 illustrates when, via an SL UE connected to an LS that is connected to a base station, the LS provides a positioning configuration, a target UE is located within network coverage, and positioning calculation is performed by the LS. Part (b) of FIG. 6 may correspond to case 8 in Table 1. The LS connected to the UE may provide positioning configuration information by using a positioning protocol, such as LPP. In addition, since the target UE performs positioning measurement based on the received configuration information and positioning signal, and is within the base station coverage, the measured positioning information may be reported to the base station. Therefore, the measurement information is reported to the LS connected to the base station, and the LS may perform positioning calculation.

Part (c) of FIG. 6 illustrates when, via an SL UE connected to an LS, the LS provides a positioning configuration, and the LS performs positioning calculation via the SL UE connected to the LS. Part (c) of FIG. 6 may correspond to case 9 in Table 1. For (c) of FIG. 6, the LS connected to the UE may provide positioning configuration information by using a positioning protocol, such as LPP. In addition, since the target UE performs positioning measurement based on the received configuration information and positioning signal, and is within SL coverage of the UE connected to the LS, the measured positioning information may be reported to the UE connected to the LS. T(c) of FIG. 6 illustrates the anchor UE (RSU) as the UE connected to the LS, but the UE connected to the LS may, of course, be a UE other than an RSU. Thereafter, the measurement information is reported to the LS connected to the anchor UE (RSU), and the LS may perform positioning calculation.

Positioning configuration may be performed when a request for positioning (e.g., a location service request) occurs.

Referring back to Table 1, a subject performing positioning configuration may be a UE (no LS), an LS (through BS), or an LS (through UE). The LS (through UE) indicates when an LS is installed in or connected to a UE, and may be referred to as server UE. According to various embodiments, it is obvious that a UE which may be a server UE is not limited to a specific UE. For example, a target UE may be a server UE, or an anchor UE may be a server UE. Alternatively, a different UE than a target UE and an anchor UE may be a server UE. The name server UE may be replaced with another term having a similar meaning.

A subject performing positioning configuration may determine a target UE and anchor UE(s) performing SL positioning. The subject performing positioning configuration may determine multiple anchor UEs as candidate UEs when performing absolute positioning. The subject performing positioning configuration may discover, via a discovery procedure, a target UE and anchor UE(s) capable of performing SL positioning. The procedure by which the subject performing positioning configuration performs discovery is not limited to a specific method. For example, the subject performing positioning configuration may discover a target UE and anchor UE(s), and trigger the UEs to transmit a positioning signal or to report a positioning measurement result. The positioning signal may include an SL positioning reference signal (SL PRS).

Herein, detailed descriptions are provided for UE operations of triggering transmission of a positioning signal or requesting a positioning measurement result according to a positioning method supported in an SL, and operations of a UE receiving such indications.

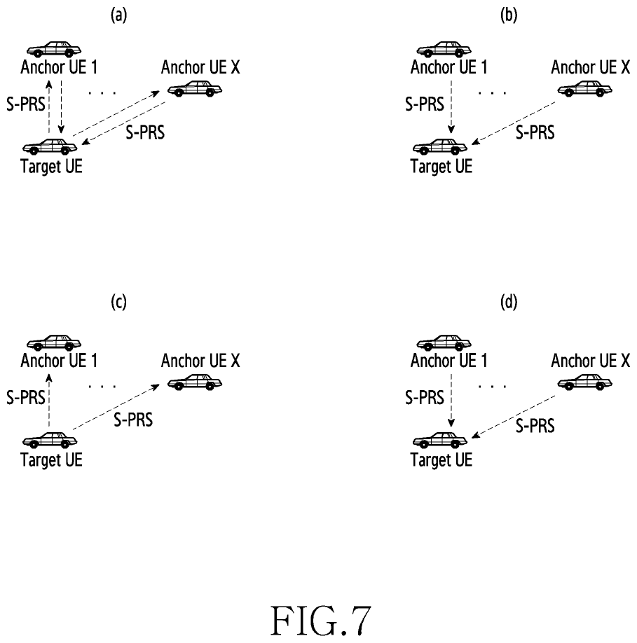

FIG. 7 illustrates various examples of SL location measurement according to an embodiment. More specifically, FIG. 7 illustrates an SL-RTT, an SL reference signal time difference (SL-RSTD), an SL relative time of arrival (RTOA), and an SL angle of arrival (SL-AoA). However, the SL positioning method of the disclosure is not limited thereto.

Referring to FIG. 7, it is noted that a subject performing positioning configuration is not illustrated. TAs described above with reference to Table 1, a UE (no LS), an LS (through BS), or an LS (through UE) may be a subject performing positioning configuration. The LS (through UE) may be referred to as server UE, and it is obvious that a server UE may be a target UE, another anchor UE, or a UE that is neither a target UE nor an anchor UE. For example, a server UE may be an RSU and a UE.

Referring to part (a) of FIG. 7, a description is provided for a method in which an SL-RTT is measured using an SL PRS transmitted via an SL. A target UE may transmit SL PRSs to surrounding anchor UEs for SL-RTT measurement. In this case, triggering SL PRS transmission of the target UE may involve the UE itself (e.g., UE (no LS)), an LS connected to a BS (e.g., LS (through BS)), or a server UE (e.g., LS (through UE)).

In order for the target UE to perform SL-RTT measurement, anchor UE(s) may receive an SL PRS transmitted by the target UE and transmit an SL PRS to the target UE. The anchor UE(s) needs to receive the SL PRS transmitted by the target UE and report a time difference (e.g., Rx-Tx time difference) occurring when transmitting an SL PRS to the target UE. Triggering of SL PRS transmission to the target UE by the anchor UE(s) and requesting of Rx-Tx time difference reporting may involve the UE itself (e.g., UE (no LS)), the LS connected to the BS (e.g., LS (through BS)), or the server UE (e.g., LS (through UE)).

Hereinafter, a first embodiment considers when the triggering of SL PRS transmission to the target UE by the anchor UE(s) and the requesting of Rx-Tx time difference reporting are performed by the target UE. In this case, the target UE may include a server UE (e.g., LS (through UE)) or a UE (e.g., UE (no LS)) that is not connected to an LS.

Referring to part (b) of FIG. 7, a description is provided for a method of measuring an SL reference signal time difference (SL-RSTD) by using an SL PRS transmitted via an SL. For SL-RSTD measurement of a target UE, surrounding anchor UE(s) may transmit an SL PRS to the target UE. In this case, triggering SL PRS transmission of the anchor UE(s) may involve the UE itself (e.g., UE (no LS)), an LS connected to a BS (e.g., LS (through BS)), or a server UE (e.g., LS (through UE)). Hereinafter, the first embodiment considers when the triggering of SL PRS transmission of the anchor UE(s) is performed by the target UE. In this case, the target UE may include a server UE (e.g., LS (through UE)) or a UE (e.g., UE (no LS)) that is not connected to an LS.

Referring to part (c) of FIG. 7, a description is provided for a method of measuring SL relative time of arrival (SL-RTOA) by using an SL PRS transmitted via an SL. For positioning of a target UE, the target UE may transmit SL PRSs to surrounding anchor UEs. In this case, triggering SL PRS transmission of the target UE may involve the UE itself (e.g., UE (no LS)), an LS connected to a BS (e.g., LS (through BS)), or a server UE (e.g., LS (through UE)).

For positioning of the target UE, the anchor UE(s) may receive the SL PRS transmitted by the target UE and measure RTOA and report the RTOA to the target UE. Requesting of RTOA reporting transmitted to the target UE by the anchor UE(s) may involve the UE (e.g., UE (no LS)), the LS connected to the BS (e.g., LS (through BS)), or the server UE (e.g., LS (through UE)).

The first embodiment considers when triggering of SL PRS transmission to the target UE by the anchor UE(s) and requesting of Rx-Tx time difference reporting are performed by the target UE. In this case, the target UE may include a server UE (e.g., LS (through UE)) or a UE (e.g., UE (no LS)) that is not connected to an LS.

Referring to part (d) of FIG. 7, a description is provided for a method of measuring an SL angle of arrival (SL-AoA) by using an SL PRS transmitted via an SL. For SL-AoA measurement of a target UE, surrounding anchor UE(s) may transmit an SL PRS to the target UE. In this case, triggering SL PRS transmission of the anchor UE(s) may involve the UE (e.g., UE (no LS)), an LS connected to a BS (e.g., LS (through BS)), or a server UE (e.g., LS (through UE)). Hereinafter, the first embodiment considers when the triggering of SL PRS transmission of the anchor UE(s) is performed by the target UE. In this case, the target UE may include a server UE (e.g., LS (through UE)) or a UE (e.g., UE (no LS)) that is not connected to an LS.

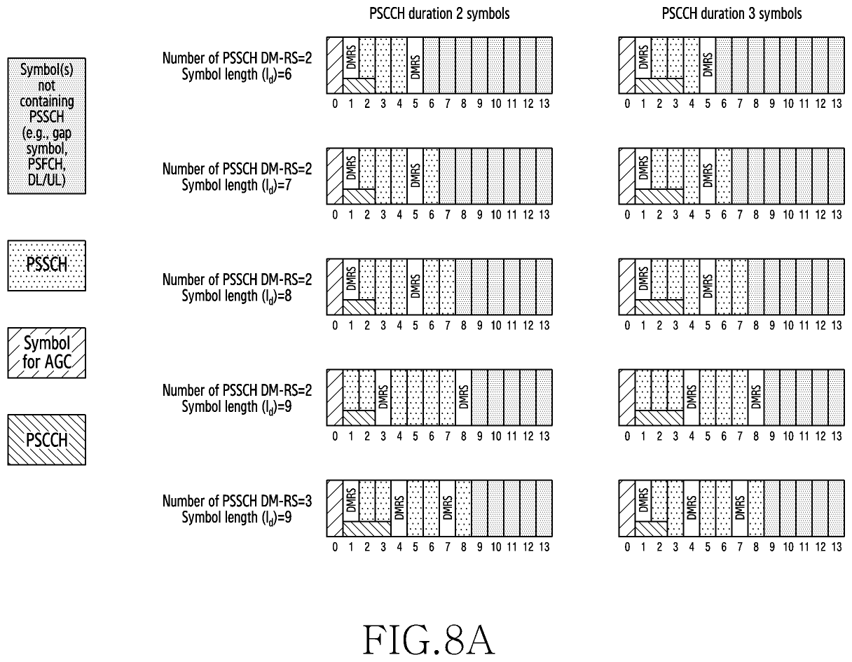

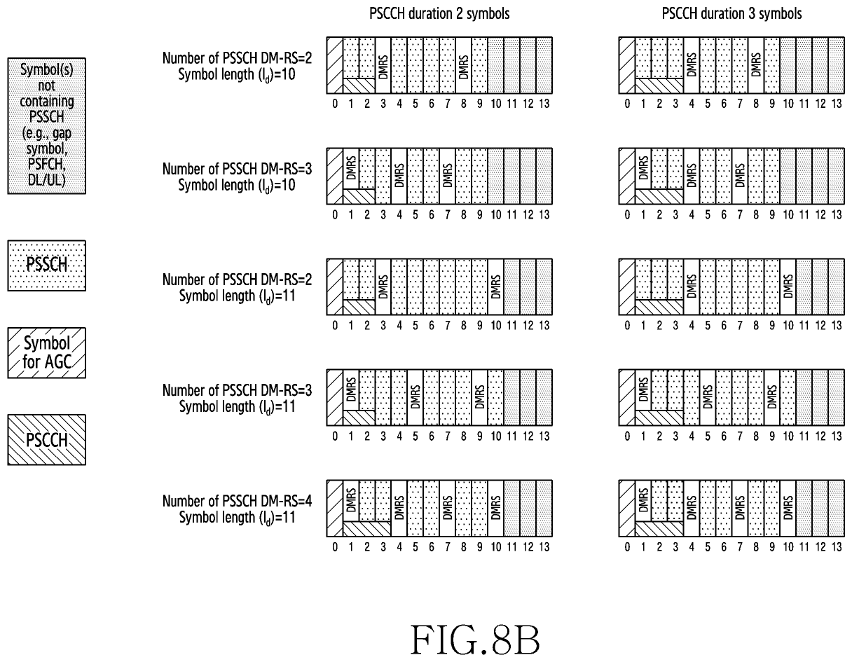

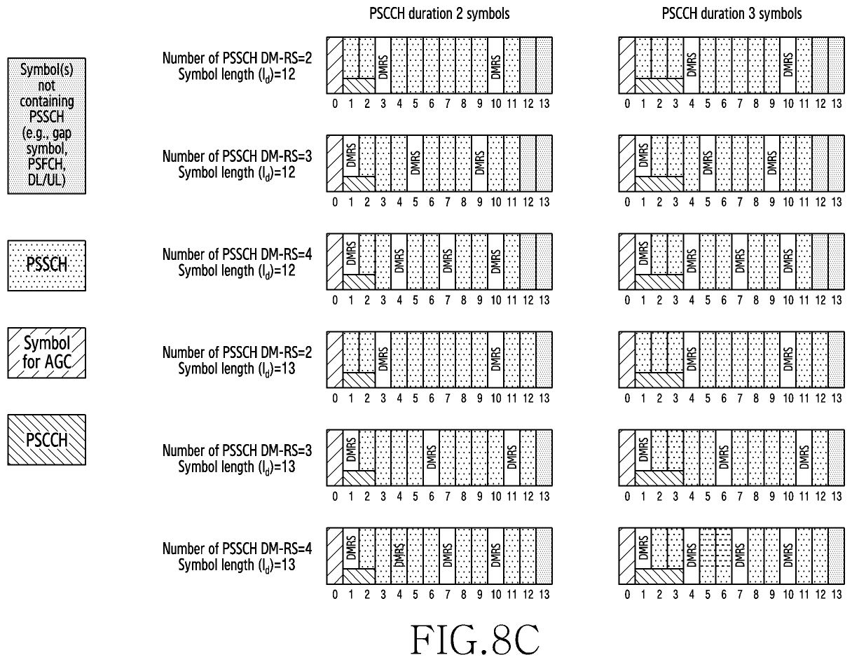

FIG. 8A illustrates an example of various physical layer structures for SL communication according to an embodiment. FIG. 8B illustrates an example of various physical layer structures for SL communication according to an embodiment. FIG. 8C illustrates an example of various physical layer structures for SL communication according to an embodiment. FIG. 8A to FIG. 8C illustrate physical layer structures in which a PSCCH/PSSCH is transmitted for SL communication (e.g., data transmission).

Referring to FIGS. 8A, 8B and FIG. 8C, a PSCCH symbol length may be configured to be 2 symbols or 3 symbols. A symbol length (ld) of an area in which a PSCCH/PSSCH is transmitted may be from 6 to 13, including an AGC symbol in a first symbol. In addition, when considering one gap symbol in a last symbol, a symbol length (sl-Lensedgthsymbols) used for an SL operation in one slot may be configured to be one value among {sym7, sym8, sym9, sym10, sym11, sym12, sym13, sym14}. In addition, a start position (sl-Startsymbol) of the symbol used for the SL operation in one slot may be configured to be one value among {sym0, sym1, sym2, sym3, sym4, sym5, sym6, sym7}. FIGS. 8A, 8B and FIG. 8C illustrate when sl-Startsymbol=sym0 is configured.

The number of PSSCH DMRS symbols may be configured to be from 2 symbols to 4 symbols, and one or more numbers of PSSCH DMRS symbols may be configured. When one or more numbers of PSSCH DMRS symbols are configured, a UE may determine the number of PSSCH DMRS symbols and indicate the number via 1st SCI. The 1st SCI may be transmitted via a PSCCH. FIG. 8A to FIG. 8C illustrate various cases in which an SL channel and a reference signal are transmitted based on the configured PSCCH symbol length, the ld determined from the configured sl-Lengthsymbols, and the configured and determined number of DMRS symbols.

An SL PTRS is a reference signal for phase tracking of a PSSCH, and a location of a resource element (RE) at which an SL PTRS is transmitted in a slot may be determined by a time density value (L_{PT-RS}) for an SL PTRS pattern, a frequency density value (K_{PT-RS}) for the SL PTRS pattern, an SL PTRS RE offset value (K_{ref}^{RE}), an SL PTRS RB offset value (K_{ref}^{RB}), or the like.

In Table 2 below, time density values (L_{PT-RS}) for the SL PTRS pattern are illustrated. The L_{PT-RS} values may be determined by configured MCS range values. For example, as shown in Table 2, the MCS range values of ptrs-MCS1, ptrs-MCS2, ptrs-MCS3, and ptrs-MCS4 may be (pre-) configured, and L_{PT-RS} may be determined by a scheduled MCS. ptrs-MCS4 is not separately configured and may be determined based on a maximum MCS value in an MCS table used for an SL. Specifically, according to Table 2, ptrs-MCS1-5 and ptrs-MCS2=10 are configured, the scheduled MCS is 3, no PTRS may be transmitted, and the scheduled MCS is 7, an SL PTRS may be transmitted in every OFDM symbol.

TABLE 2

| Scheduled MCS | Time density (L_{PT-RS}) |
|---|---|
| I_{MCS} < ptrs − MCS1 | PT-RS is not present |
| ptrs − MCS1 < I_{MCS} < ptrs − MCS2 | 4 |
| ptrs − MCS2 < I_{MCS} < ptrs − MCS3 | 2 |
| ptrs − MCS3 < I_{MCS} < ptrs − MCS4 | 1 |

In Table 3 below, frequency density values (K_{PT-RS}) for the SL PTRS pattern are illustrated. A K_{PT-RS} value may be determined by a configured frequency range value. For example, the frequency range value is the number of RBs and may be (pre-) configured as N_{RB0} or N_{RB1}, and K_{PT-RS} may be determined by the number of scheduled RBs. Specifically, according to Table 3, N_{RB0}=4 or N_{RB1}=10 is configured, the number of scheduled RBs is 2, no PTRS may be transmitted, and the number of scheduled RBs is 20, an SL PTRS may be transmitted in every 4 RBs in frequency.

TABLE 3

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

In Table 4 below, SL PTRS RE offset (K_{ref}^{RE}) values are illustrated. According to DMRS configuration type1 and type2, reference RE locations (K_{ref}^{RE}) at which a PTRS is transmitted in a DMRS antenna port are described. Depending on a (pre-) configured resourceElementOffset value, an RE location in frequency, at which a PTRS is transmitted, in an RB may be determined. By changing a corresponding value, a location at which an SL PTRS is transmitted may be randomized. For example, when corresponding configuration is performed for each resource pool, there may be an effect of randomizing an influence of SL PTRS interference between resource pools.

TABLE 4

| | K_{ref}^{RE} | | | | | | | |
|---|---|---|---|---|---|---|---|---|
| DM-RS | DM-RS Configuration type 1 | | | | DM-RS Configuration type 2 | | | |
| antenna | resourceElementOffset | | | | resourceElementOffset | | | |
| port | 00 | 01 | 10 | 11 | 00 | 01 | 10 | 11 |
| 0 | 0 | 2 | 6 | 8 | 0 | 1 | 6 | 7 |
| 1 | 2 | 4 | 8 | 10 | 1 | 6 | 7 | 0 |
| 2 | 1 | 3 | 7 | 9 | 2 | 3 | 8 | 9 |
| 3 | 3 | 5 | 9 | 11 | 3 | 8 | 9 | 2 |
| 4 | — | — | — | — | 4 | 6 | 10 | 11 |
| 5 | — | — | — | — | 5 | 10 | 11 | 4 |

An SL PTRS RB offset value (KRB) may be determined by a 16-bit value corresponding to a least significant bit (LSB) of a cyclic redundancy check (CRC) used in a PSCCH.

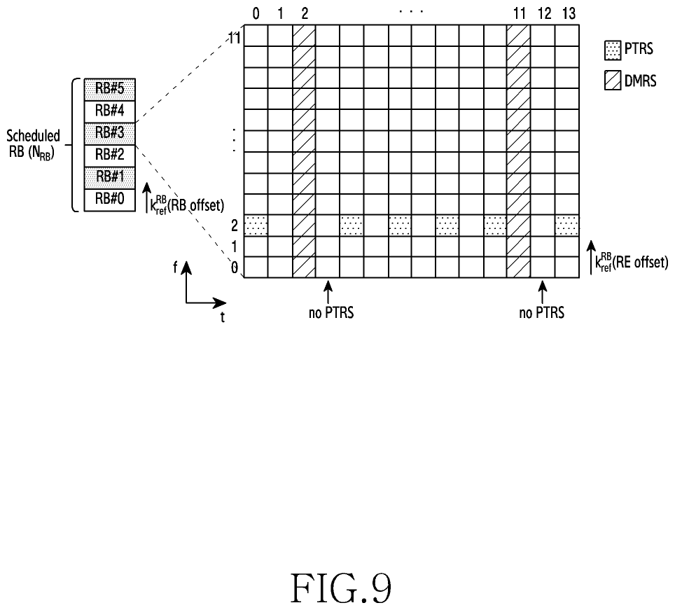

FIG. 9 illustrates an example of a location at which an SL PTRS is transmitted according to an embodiment.

Referring to FIG. 9, an example of locations at which an SL PTRS is transmitted is illustrated, the locations being determined by values, such as L_{PT-RS}, K_{PT-RS}, K_{ref}^{RE}, and K_{ref}^{RB}.

FIG. 9 is directed to when L_{PT-RS}=2, K_{PT-RS}=2, K_{ref}^{RE}=2, and K_{ref}^{RB}=1 are configured. For L_{PT-RS}=2, an SL PTRS needs to be transmitted in every 2 OFDM symbols, but no PTRS may be transmitted in a symbol (e.g., symbol index=2) in which a PSSCH DMRS is transmitted. This is because, since a PTRS uses the same sequence as a PSSCH DMRS, the PSSCH DMRS may be used for phase tracking. Referring to symbol index=12 in FIG. 9, since the PSSCH DMRS is transmitted in a previous symbol so as to be used for phase tracking, SL PTRS transmission may not be performed, and a PTRS may be transmitted in a subsequent symbol index=13 by shifting one symbol.

An SL channel state information reference signal (SL CSI-RS) identifies a channel state of a PSSCH, and CSI-RS transmission may be limited to unicast transmission, or an area in which the SL CSI-RS is transmitted may be limited to a scheduled PSSCH area. An RE location at which the SL CSI-RS is transmitted in a slot may be determined based on information of frequency RE location k₀ and symbol position l₀, and the information may be configured via PC5-RRC.

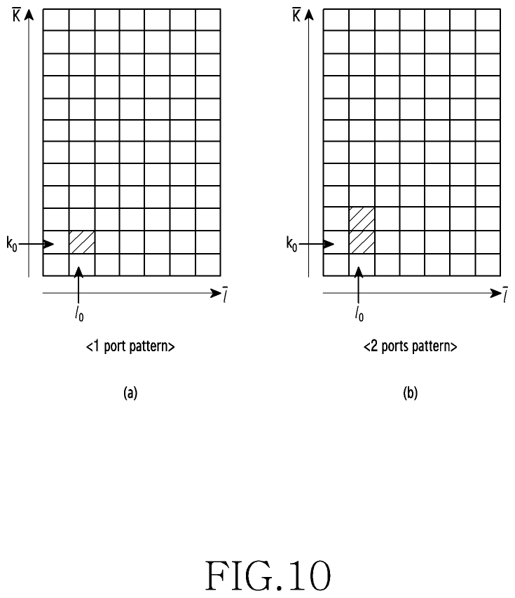

FIG. 10 illustrates an example of a resource for transmitting an SL channel state information (CSI)-reference signal (RS) according to an embodiment.

Referring to FIG. 10, an example of locations at which an SL CSI-RS is transmitted is illustrated, the locations being determined by k₀ and l₀ values.

Part (a) of FIG. 10 illustrates when 1 port SL CSI-RS is transmitted and part (b) of FIG. 10 illustrates when 2 port SL CSI-RS is transmitted. As shown in FIG. 10, frequency position k₀ and symbol position l₀ of an RE in which an SL CSI-RS is transmitted may be configured via PC5-RRC, and a UE which performs SL unicast transmission and reception may interpret configuration information, and transmit and receive an SL CSI-RS accordingly.

### First Embodiment

In the first embodiment, resource information of an SL PRS and a configuring method therefor are described. In particular, the description is provided based on when an SL PRS is transmitted in a resource pool (which may be referred to as a shared resource pool with SL communication) where SL communication (data transmission) is performed.

When an SL PRS is transmitted in a resource pool where SL communication (data transmission) is performed, at least one of the following information may be (pre-) configured.
SL PRS resource information 1: SL PRS resource ID
SL PRS resource information 2: The number (M) of symbols and a symbol start position of an SL PRS in a slot
SL PRS resource information 3: Comb size (N) and Comb offset information of an SL PRS

The SL PRS resource information 1 may include ID information determined by SL PRS resource information 2 and 3. When an SL PRS is transmitted in a resource pool in which SL communication (data transmission) is performed, a frequency resource location at which the SL PRS is transmitted may be determined by a location of a frequency resource allocated as a PSSCH transmission resource. Therefore, one SL PRS resource may be identified by SL PRS resource information 1 and the frequency location at which the SL PRS is transmitted.

When an SL PRS is transmitted in a resource pool in which SL communication (data transmission) is performed, a symbol area in which the SL PRS is transmitted may be determined based on SL PRS resource information 2. A case in which a PSSCH and the SL PRS are time domain multiplexed (TDMed) and transmitted in one slot, may be considered. However, when a symbol area in which the SL PRS is transmitted is determined, at least one of the following conditions needs to be satisfied.

Condition 1: A symbol length transmitted as an SL PRS resource may be configured to be one of {sym1, sym2, sym4}. However, the symbol length transmitted as the SL PRS resource is not limited to {sym1, sym2, sym4}. Sym1, sym2, and sym4 may correspond to symbol lengths 1, 2, and 4, respectively.

Condition 2: An SL PRS resource may be transmitted in symbols consecutive in time.

Condition 3: An SL PRS resource may not be transmitted in a symbol in which a PSSCH DMRS is transmitted.

Condition 4: An SL PRS resource may not be transmitted in a symbol in which a PSCCH is transmitted.

Condition 5: An SL PRS resource may be transmitted after a symbol in which 2nd SCI is transmitted. The 2nd SCI may be mapped on and transmitted from a first PSSCH DMRS symbol.

Condition 6: An SL PRS resource may not be transmitted before a first PSSCH DMRS symbol.

Condition 7: An SL PRS resource may be mapped on a last symbol area of a slot in consideration of other reference signals, other channels, GAP symbols, or AGC symbols, to minimize possible combinations in which the SL PRS resource is mapped on a PSSCH area. If the possible combinations are minimized, it is advantageous that the number of bits of information indicating an SL PRS ID may be reduced.

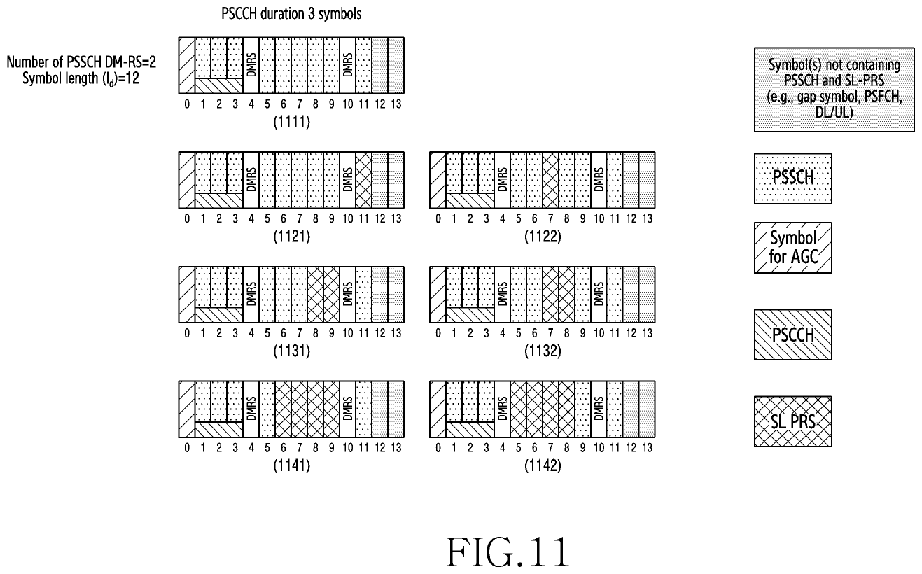

FIG. 11 illustrates an example of an SL positioning reference signal (PRS) in a resource pool where SL communication is performed according to an embodiment.

Referring to FIG. 11, a description is provided for an example of a location at which an SL PRS may be transmitted based on the aforementioned condition 1 to condition 7 when the SL PRS is transmitted in a resource pool (which may be referred to as a shared resource pool with SL communication) in which SL link communication (data communication) is performed.

Referring to FIG. 11, a description is provided for when an SL PRS is TDMed to a part of an area, in which a PSSCH is transmitted, so as to be transmitted in one slot.

Specifically, (1111) of FIG. 11 illustrates a case where a PSCCH symbol length is 3 symbols, the number of PSSCH DMRS symbols is 2, and a symbol length (l_d) of an area in which a PSCCH/PSSCH is transmitted is 12.

(1121) and (1122) of FIG. 11 illustrate when an SL PRS symbol length is configured as M=1. According to condition 7 described above, since an SL PRS needs to be mapped on a last area of a mappable slot of a PSSCH, a configuration of mapping an SL PRS symbol on symbol index=7 to perform transmission, as in (1122) of FIG. 11, is not performed, and a configuration of mapping an SL PRS symbol on symbol index=11 to perform transmission, as in (1121) of FIG. 11, may be performed.

(1131) and (1132) of FIG. 11 illustrate when an SL PRS symbol length is configured as M=2. According to condition 7 described above, since an SL PRS needs to be mapped on a last area of a mappable slot of a PSSCH, a configuration of mapping SL PRS symbols on symbol indexes=7 and 8 to perform transmission, as in (1132) of FIG. 11, is not performed, and a configuration of mapping SL PRS symbols on symbol indexes=8 and 9 to perform transmission, as in (1131) of FIG. 11, may be performed. By condition 3, an SL PRS cannot be configured to be mapped on symbol indexes=4 and 10, and also, by condition 2, SL PRS symbols cannot be configured to be mapped on non-consecutive symbols, such as symbol indexes=9 and 11.

(1141) and (1142) of FIG. 11 illustrate when an SL PRS symbol length is configured as M=4. According to condition 7 described above, since an SL PRS needs to be mapped on a last area of a mappable slot of a PSSCH, a configuration of mapping SL PRS symbols on symbol indexes=5, 6, 7, and 8 to perform transmission, as in (1142) of FIG. 11, is not performed, and a configuration of mapping SL PRS symbols on symbol indexes=6, 7, 8, and 9 to perform transmission, as in (1141) of FIG. 11, may be performed. By condition 3, an SL PRS cannot be configured to be mapped on symbol indexes=4 and 10, and also, by condition 2, SL PRS symbols cannot be configured to be mapped on non-consecutive symbols, such as symbol indexes=7, 8, 9, and 11, to perform transmission.

When an SL PRS is transmitted in a resource pool in which SL data transmission is performed, a frequency domain in which the SL PRS is transmitted may be determined based on SL PRS resource information 3 described above.

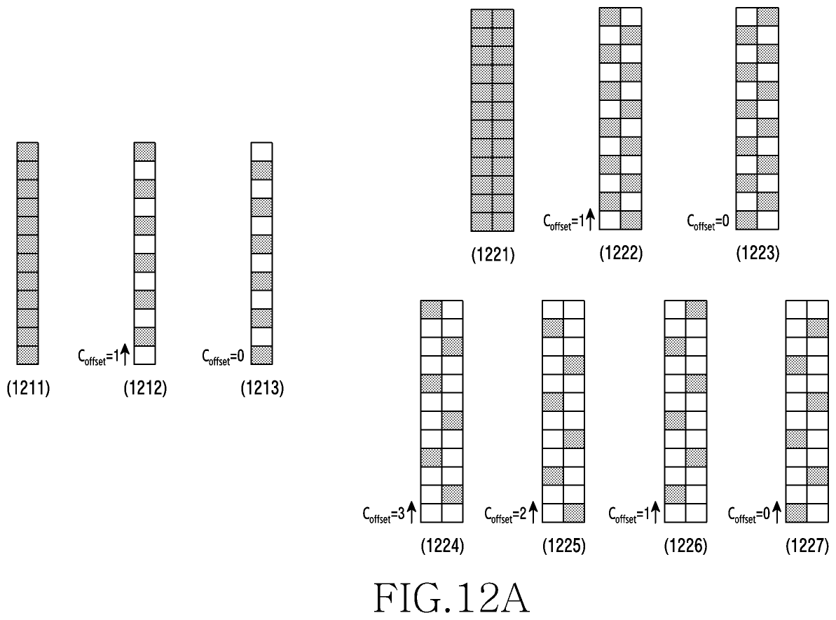

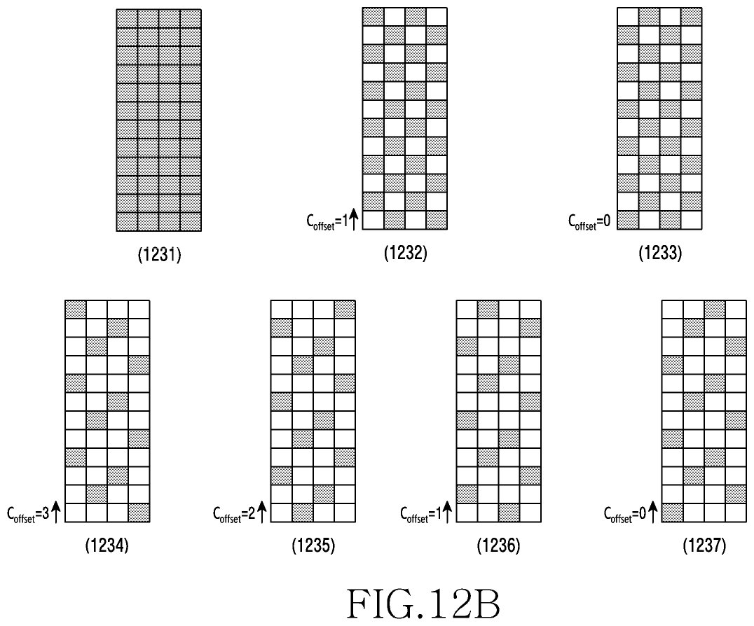

FIG. 12A and FIG. 12B illustrate frequency patterns in which an SL PRS is transmitted according to an embodiment. Referring to FIG. 12A and FIG. 12B, illustrated are SL PRS frequency patterns with respect to a combination (M, N) of an SL PRS symbol length M and an SL PRS comb size N, wherein (M, N)=(1, 1), (M, N)=(1, 2), (M, N)=(2, 1), (M, N)=(2, 2), (M, N)=(2, 4), (M, N)=(4, 1), (M, N)=(4, 2), and (M, N)=(4, 4). However, SL PRS frequency patterns are not limited to the patterns illustrated in FIG. 12A and FIG. 12B. A staggered pattern as in Table 5 below may be applied according to an SL PRS comb size and an SL PRS symbol index.

TABLE 5

| Comb | Symbol index of SL positioning reference signal | | | | | | | | | | | | | |
|---|---|---|---|---|---|---|---|---|---|---|---|---|---|---|
| size, N | 0 | 1 | 2 | 3 | 4 | 5 | 6 | 7 | 8 | 9 | 10 | 11 | 12 | 13 |
| 1 | 0 | 0 | 0 | 0 | 0 | 0 | 0 | 0 | 0 | 0 | 0 | 0 | 0 | 0 |
| 2 | 0 | 1 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 | 0 | 2 |
| 6 | 0 | 3 | 1 | 4 | 2 | 5 | 0 | 3 | 1 | 4 | 2 | 5 | 0 | 3 |
| 8 | 0 | 4 | 2 | 6 | 1 | 5 | 3 | 7 | 0 | 4 | 2 | 6 | 0 | 4 |
| 12 | 0 | 6 | 3 | 9 | 1 | 7 | 4 | 10 | 2 | 8 | 5 | 11 | 0 | 6 |

Table 5 shows comb size and offset (staggered pattern offset) information applied to each symbol. In Table 5, if an SL PRS symbol length M is greater than a Comb size N (M>N), a comb offset of first N symbols may be repeatedly applied in the same manner in last (M-N) symbols.

FIG. 12A illustrates when an SL PRS symbol length is configured as M=1. Specifically, (1211) of FIG. 12 illustrates an SL PRS frequency pattern for when N=1. (1212) of FIG. 12 illustrates an SL PRS frequency pattern for when N=2 and Comb offset=1. (1213) of FIG. 12 illustrates an SL PRS frequency pattern for when N=2 and Comb offset=0.

FIG. 12A also illustrates when an SL PRS symbol length is configured as M=2. Specifically, (1221) of FIG. 12A illustrates an SL PRS frequency pattern for when N=1. (1222) of FIG. 12A illustrates an SL PRS frequency pattern for when N=2 and Comb offset=1. (1223) of FIG. 12A illustrates an SL PRS frequency pattern for when N=2 and Comb offset=0. (1224) of FIG. 12A illustrates an SL PRS frequency pattern for when N=4 and Comb offset=3. (1225) of FIG. 12A illustrates an SL PRS frequency pattern for when N=4 and Comb offset=2. (1226) of FIG. 12A illustrates an SL PRS frequency pattern for when N=4 and Comb offset=1. (1227) of FIG. 12A illustrates an SL PRS frequency pattern for when N=4 and Comb offset=0.

FIG. 12B illustrates when an SL PRS symbol length is configured as M=4. Specifically, (1231) of FIG. 12B illustrates an SL PRS frequency pattern for when N=1. (1232) of FIG. 12B illustrates an SL PRS frequency pattern for when N=2 and Comb offset=1. (1223) of FIG. 12B illustrates an SL PRS frequency pattern for when N=2 and Comb offset=0. (1224) of FIG. 12B illustrates an SL PRS frequency pattern for when N=4 and Comb offset=3. (1225) of FIG. 12B illustrates an SL PRS frequency pattern for when N=4 and Comb offset=2. (1226) of FIG. 12B illustrates an SL PRS frequency pattern for when N=4 and Comb offset=1. (1227) of FIG. 12B illustrates an SL PRS frequency pattern for when N=4 and Comb offset=0.

### Second Embodiment

The second embodiment describes a method of multiplexing with an SL PTRS when an SL PRS is transmitted in a resource pool (which may be referred to as a shared resource pool with SL communication) in which SL communication (data transmission) is performed. The detailed description of the SL PTRS patterns is provided with reference to FIG. 9. In addition, the detailed description of the SL PRS patterns is provided with reference to FIGS. 12A and 12B.

For example, referring back to FIG. 9, if a time density value (L_{PT-RS}) for an SL PTRS pattern is 1, the SL PTRS may be transmitted in every OFDM symbol. In addition, referring to FIGS. 12A and 12B, if a Comb size (N) of the SL PRS is 1, a frequency domain in which the SL PRS is transmitted is all REs, and the SL PRS may be transmitted accordingly. Therefore, depending on an SL PTRS pattern and an SL PRS pattern, there may be when two RSs overlap, where overlapping may refer to collision of two RSs.

In order to avoid when an SL PTRS pattern and an SL PRS pattern overlap, various methods may be considered as follows.
Alternative 1: SL PRS is not mapped on symbols occupied by SL PTRS
Alternative 2: SL PTRS is not mapped on symbols occupied by SL PRS
Alternative 3: SL PTRS is shifted next to SL PRS symbol
Alternative 4: SL PRS is not mapped on REs occupied by SL PTRS (Two reference signals can be overlapped)
Alternative 5: SL PTRS is not mapped on REs occupied by SL PRS (Two reference signals can be overlapped)
Alternative 6: Two reference signals are not overlapped by configuration of SL PTRS/SL PRS location (UE is not expected the collision of SL PRS and SL PTRS.)
Alternative 7: Combination of above alternatives (e.g., Alt. 4 is applied for N=1, Alt. 6 is applied for N=2 and 4)

The aforementioned alternatives may be methods for preventing two RSs from overlapping or colliding in advance. Alternatively, methods of performing operation without a problem even when two RSs overlap or collide may be considered. To this end, at least one method of randomly selecting and processing one of two RSs, interpreting a collision as an error so as not to perform any functions, or processing both RSs at an overlapping location may be considered. All these UE operations may be interpreted as operations that a UE does not expect two RSs to overlap or collide.

Alternative 1 is a method of preventing, based on a symbol level, a case where a pattern of an SL PTRS and a pattern of an SL PRS overlap, in which case, the SL PTRS is given higher priority, and the SL PRS is not mapped on a symbol overlapping with the SL PTRS, thereby preventing collision between the two RSs.

However, for alternative 1, transmission of the SL PRS may be greatly limited. For example, if a time density value (L_{PT-RS}) for the SL PTRS pattern is 1, the SL PTRS is transmitted in every OFDM symbol, so that there may be when the SL PRS cannot be transmitted. In addition, depending on a time density value (L_{PT-RS}) for the SL PTRS pattern, a condition (e.g., condition 2 of the first embodiment) that an SL PRS resource needs to be transmitted in consecutive symbols in time may not be satisfied.

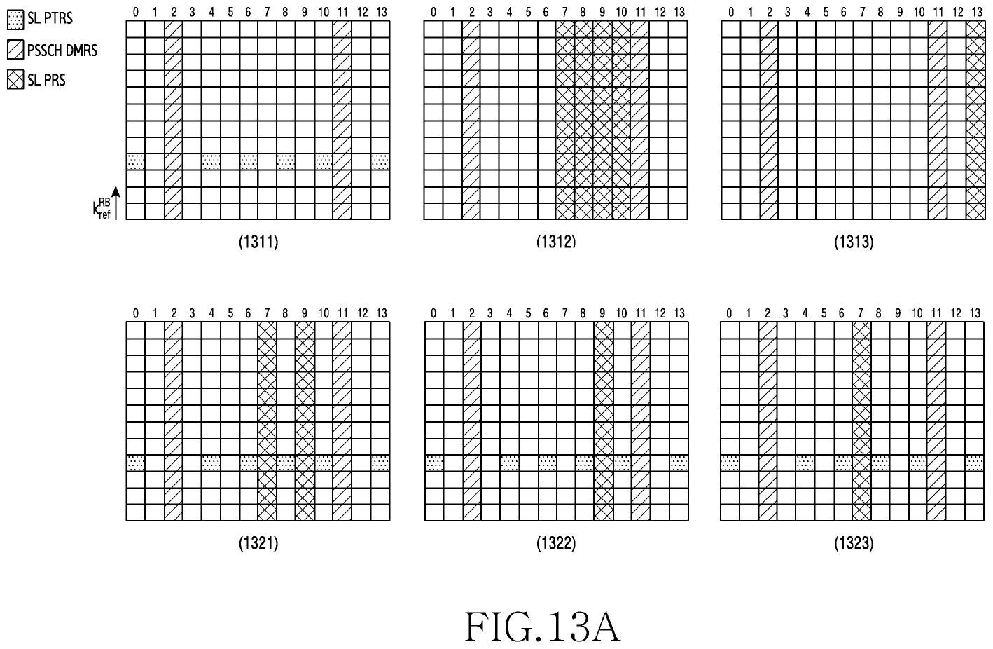

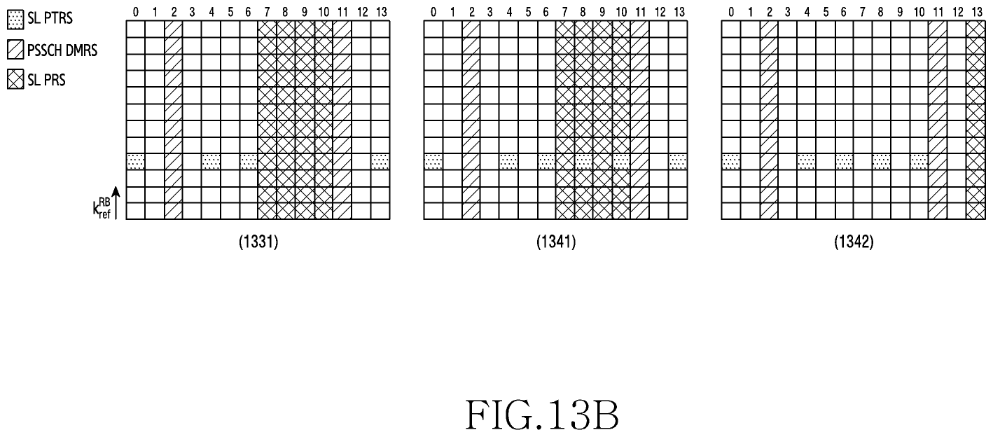

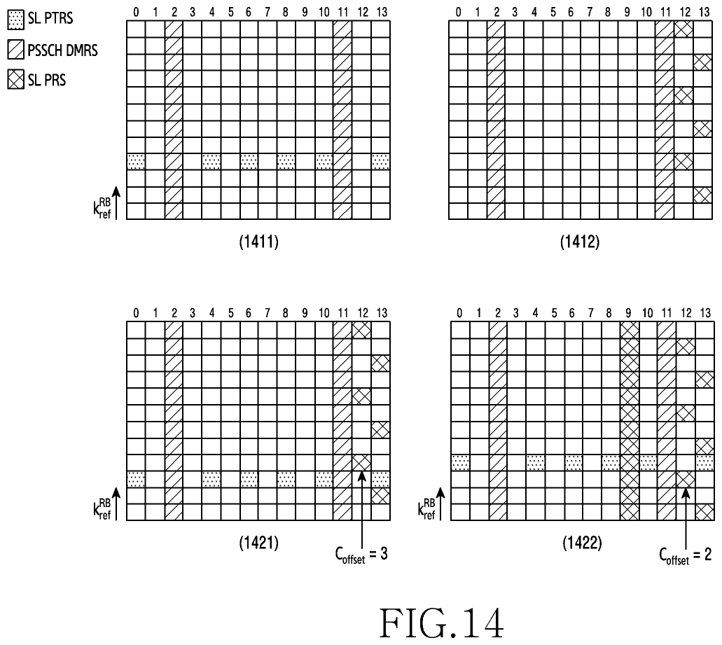

FIG. 13A, FIG. 13B, and FIG. 14 illustrate various examples of resources for SL transmission according to an embodiment.

Referring to FIG. 13A, an example of when an SL PTRS pattern and an SL PRS pattern overlap is illustrated. Specifically, (1311) of FIG. 13 illustrates when L_{PT-RS}=2. (1312) of FIG. 13 illustrates when (M, N)=(4,1).

When the PTRS pattern and the SL PRS pattern according to (1311) of FIG. 13A and (1313) of FIG. 13A overlap, (1321), (1322), (1323), (1331), or (1341) of FIG. 13A and FIG. 13B may be applied. When the PTRS pattern and the SL PRS pattern according to (1311) of FIG. 13A and (1313) of FIG. 13A overlap, and (M, N)=(1,1), (1331) of FIG. 13A may be applied to (1342) of FIG. 13B.

Referring to FIG. 13A, (1321) illustrates a method of not mapping, by alternative 1, an SL PRS on a symbol overlapping with an SL PTRS. However, in this regard, exceptionally, condition 2 of the first embodiment may not be applied.

(1322) of FIG. 13A illustrates when, even when alternative 1 is applied, condition 2 of the first embodiment may be satisfied, and a method of not mapping an SL PRS on preceding symbol(s) in non-consecutive symbols is additionally applied by further considering condition 7 of the first embodiment. Specifically, no SL PRS symbol may be mapped on transmission symbol index=7.

(1323) of FIG. 13A illustrates when, even when alternative 1 is applied, a method of not mapping an SL PRS on subsequent symbol(s) in non-consecutive symbols is additionally applied to satisfy condition 2 of the first embodiment. Specifically, no SL PRS symbol may be mapped on transmission symbol index=9. For (1323) of FIG. 13A, condition 7 of the first embodiment may not be satisfied.

Alternative 2 also includes a method of preventing, based on a symbol level, a case where a pattern of an SL PTRS and a pattern of an SL PRS overlap, in which case, the SL PRS is given higher priority, and the SL PTRS is not mapped on a symbol overlapping with the SL PRS, thereby preventing collision between the two RSs. However, for alternative 2, performance of phase tracking may not be guaranteed. Since the SL PRS and the SL PTRS do not use the same sequence, the SL PRS may not be used, together with the SL PTRS, for phase tracking.

(1331) of FIG. 13B illustrates a method of not mapping, by alternative 2, an SL PTRS on a symbol overlapping with an SL PRS. In this case, L_{PT-RS}=2 may not be maintained. Therefore, performance of phase tracking may not be guaranteed.

Alternative 3 may include a method of moving an SL PTRS to a symbol before or after an SL PRS, thereby preventing a case where an SL PTRS pattern and an SL PRS pattern overlap. However, alternative 3 may have a disadvantage that it is difficult to be applied to all SL PTRS pattern and SL PRS pattern cases. In addition, similar to alternative 2, performance of phase tracking may not be guaranteed.

Alternative 4 may include a method of preventing, based on an RE level, a case where a pattern of an SL PTRS and a pattern of an SL PRS overlap, in which case, the SL PTRS is given higher priority, and the SL PRS is not mapped on an RE overlapping with the SL PTRS, thereby preventing collision between the two RSs. For alternative 4, it is assumed that the two RSs may overlap depending on configurations of the SL PTRS pattern and the SL PRS pattern. Alternative 4 may include an operation of puncturing the SL PRS in an RE overlapping with the SL PTRS. For alternative 4, when there is no mapped PSSCH after a symbol on which the SL PRS is mapped, a method of not puncturing the SL PRS in the RE overlapping with the SL PTRS may be considered. In other words, alternative 4 may be a method in which, when there is no PSSCH resource after an SL PRS symbol, an SL PRS is not mapped on an RE occupied by an SL PTRS.

A detailed description of alternative 4 will be provided with reference to FIG. 13B. (1341) of FIG. 13B illustrates when a PTRS pattern and an SL PRS pattern overlap according to (1311) and (1312) of FIG. 13A. Referring to (1341) of FIG. 13B, when the SL PTRS is transmitted as in (1312) of FIG. 13A, a method of not mapping, by alternative 4, the SL PTRS on an RE overlapping with the SL PRS is illustrated. Referring to (1342) of FIG. 13B, illustrated is when a PTRS pattern and an SL PRS pattern overlap according to (1311) and (1313) of FIG. 13A. In this case, a method of not mapping, by alternative 4, the SL PTRS on an RE overlapping with the SL PRS is illustrated. However, since no PSSCH is transmitted after a symbol on which the SL PRS is mapped, as in (1313) of FIG. 13A, a significant problem in phase tracking may not occur even if no SL PTRS is transmitted in the symbol. Therefore, an exception of not puncturing the SL PRS in an RE overlapping with the SL PTRS, as in (1313) of FIG. 13A, may be considered.

Alternative 5 may include a method of preventing, based on an RE level, a case where a pattern of an SL PTRS and a pattern of an SL PRS overlap, in which case, the SL PRS is given higher priority, and the SL PTRS is not mapped on an RE overlapping with the SL PRS, thereby preventing collision between the two RSs. In alternative 5, it is assumed that the two RSs may overlap depending on configurations of the SL PTRS pattern and the SL PRS pattern. However, for alternative 5, performance of phase tracking may not be guaranteed. Since the SL PRS and the SL PTRS do not use the same sequence, the SL PRS may not be used, together with the SL PTRS, for phase tracking.

Referring to (1331) of FIG. 13B, illustrated is a method of not mapping, by alternative 5, an SL PTRS on an RE overlapping with an SL PRS. In this case, L_{PT-RS}=2 may not be maintained. Therefore, similar to alternative 2, performance of phase tracking may not be guaranteed.

Alternative 6 may include a method of avoiding a case where two RSs overlap, via configurations of an SL PTRS pattern and an SL PRS pattern, and may include a method of avoiding a collision between two RSs in advance, via location configurations for an SL PTRS pattern and an SL PRS pattern. A detailed description of a location configuration of an SL PTRS pattern are provided with reference to FIG. 9. In addition, detailed descriptions of a location configuration of an SL PRS pattern are provided with reference to FIG. 11 and FIG. 12B.

Alternative 6 has a disadvantage that it is difficult to apply when Comb size (N) of an SL PRS is 1. Therefore, in relation to alternative 6, a method of avoiding configuration of when a Comb size (N) of the SL PRS is 1 may be included. When an SL PTRS is supported only in a frequency range 2 (FR2) area, a method of avoiding configuration of when a Comb size (N) of an SL PRS in FR2 is 1 may be included in relation to alternative 6. However, when a Comb size (N) of an SL PRS is 1, a frequency density of an SL PRS pattern is the highest, so that the highest positioning accuracy may be provided. Therefore, the method of avoiding a configuration of N=1 by alternative 6 may have a disadvantage that performance of positioning may be degraded in a specific environment. Alternative 6 may be interpreted as an operation in which a UE does not expect an SL CSI-RS pattern and an SL PRS pattern to overlap or collide.

FIG. 14 illustrates various examples of resources for SL transmission according to an embodiment.

Referring to FIG. 14, diagrams are provided for specifically illustrating alternative 6. Referring to (1411) and (1412) of FIG. 14, illustrated is an example of when an SL PTRS pattern and an SL PRS pattern overlap. Specifically, (1411) of FIG. 14 illustrates when L_{PT-RS}=2. (1412) of FIG. 14 illustrates when (M, N)=(2,4). FIG. 14 describes a case of adjusting a configuring value for an SL PTRS RE offset (K_{ref}^{RE}) value or SL PRS Comb offset value, but a method of adjusting a location configuration for an SL PTRS pattern and an SL PRS pattern is not limited thereto. For example, symbol location values for the SL PTRS pattern and the SL PRS pattern may be adjusted.

Referring to (1421) of FIG. 14, illustrated is an example of preventing when an SL PTRS pattern and an SL PRS pattern overlap, by adjusting an SL PTRS RE offset (K_{ref}^{RE}) value. (1411) of FIG. 14 illustrates when K_{ref}^{RE}=3, but (1421) of FIG. 14 illustrates when K_{ref}^{RE}=2. In this way, a K_{ref}^{RE} value may be configured to avoid a collision with the SL PRS.

Referring to (1422) of FIG. 14, illustrated is an example of preventing when an SL PTRS pattern and an SL PRS pattern overlap, by adjusting an SL PRS Comb offset value. (1412) of FIG. 14 illustrates when the Comb offset is 3, but (1422) of FIG. 14 illustrates when the Comb offset is 2. In this manner, the SL PRS Comb offset value may be configured to avoid a collision with the SL PRS.

Alternative 7 may include a method of preventing when an SL PTRS pattern and an SL PRS pattern overlap, by combining the alternatives described above. As a most preferable example, a method of enabling alternative 4 to be applied when a Comb size (N) of an SL PRS is 1, or applying alternative 6 when a Comb size (N) of an SL PRS is other than 1 (e.g., N=2 or 4) may be considered. When the method described above is used, a case where N=1 cannot be used in alternative 6 may be prevented. According to the description above, a UE operation may be defined as in Table 6 below.

TABLE 6

In a shared resource pool, if K_{comb}^{SL-PRS} = 1 and PSSCH is
occupied after SL PRS resource within a slot, SL PRS shall
not be mapped to resource elements containing PSSCH PT-RS
by puncturing SL PRS. Otherwise, a UE is not expected to
receive PSSCH PT-RS and SL PRS on the same resource elements.

Table 6 provides UE operations in which alternative 4 and alternative 6 are combined.

Alternative 1 to alternative 7 in the aforementioned embodiments are described by considering a case where an SL PTRS pattern and an SL PRS pattern may overlap. However, it is obvious that alternative 1 to alternative 7 may be equally applied even when an SL CSI-RS pattern and an SL PRS pattern may overlap. The SL PRS in alternative 1 to alternative 7 may be replaced with an SL CSI-RS. For example, when an SL PRS is transmitted in a resource pool (which may be referred to as a shared resource pool with SL communication) in which SL communication (data transmission) is performed, the methods proposed in alternative 1 to alternative 7 described above may be applied as a method of multiplexing with an SL CSI-RS. However, An SL CSI-RS pattern and an SL PRS pattern may always avoid when two RSs collide, by applying alternative 6. Therefore, As in alternative 7, a method of avoiding a collision between two RSs in advance via location configuration for an SL CSI-RS pattern and an SL PRS pattern may be the most desirable. This may be interpreted as an operation in which a UE does not expect an SL CSI-RS pattern and an SL PRS pattern to overlap or collide.

### Third Embodiment

The third embodiment specifically describes a method of determining transmission power of an SL PRS. In particular, a case where an SL PRS is transmitted in a resource pool (which may be referred to as a shared resource pool with SL communication) in which SL communication (data transmission) is performed is considered.

When an SL PRS is transmitted in a resource pool in which SL communication (data transmission) is performed, the SL PRS may be transmitted at the same power as that of a PSSCH. An open loop power control may be applied to the PSSCH, based on a pathloss between a base station and a UE or a pathloss between UEs. The SL PRS being transmitted at the same power as that of the PSSCH may indicate that the same power is maintained based on an OFDM symbol level within a slot. For example, a UE may assume that a ratio (ρ [dB]) of PSSCH energy per resource element (EPRE) to SL PRS EPRE is −10 log₁₀(N). N may denote a comb size for the SL PRS. Table 7 below shows ρ [dB] values according to comb sizes of the SL PRS.

TABLE 7

| Comb size, N | ρ [dB] |
|---|---|
| 1 | 0 |
| 2 | −3.01 |
| 4 | −6.02 |
| 6 | −7.78 |
| 8 | −9.03 |
| 12 | −10.79 |

Table 7 shows ratio (ρ [dB]) of PSSCH EPRE to SL PRS EPRE.

Unlike in Table 7, for the UE, when a ratio (ρ [dB]) of SL PRS EPRE to PSSCH EPRE is defined, a corresponding value may be calculated as 10 log₁₀(N). In this case, Table 7 may be modified as in Table 8 below, which provides ratio (ρ [dB]) of SL PRS EPRE to PSSCH EPRE.

TABLE 8

| Comb size, N | ρ [dB] |
|---|---|
| 1 | 0 |
| 2 | 3.01 |
| 4 | 6.02 |
| 6 | 7.78 |
| 8 | 9.03 |
| 12 | 10.79 |

Table 7 and Table 8 describe the ratios of SL PRS EPRE and PSSCH EPRE when no SL PTRS exists. As described in FIGS. 13A-13B and FIG. 14, an SL PTRS may be transmitted in a symbol in which an SL PRS is transmitted. In this case, to maintain power of OFDM symbols the same, a ratio (ρ [dB]) of SL PRS EPRE to PSSCH EPRE may be defined as illustrated in Table 9. No PSSCH may be transmitted in a symbol in which an SL PRS is transmitted. Therefore, when an SL PRS RE and an SL PTRS RE exist in the corresponding symbol, as a method of maintaining the same power as that of a symbol in which a PSSCH is transmitted, the ratio of EPRE may be defined by the equations illustrated in Table 9 below, which provides ratio (ρ [dB]) of SL PRS EPRE to PSSCH EPRE when SL PTRS is transmitted in a symbol in which SL PRS is transmitted.

TABLE 9

| Comb size, N | ρ [dB] |
|---|---|
| 1 | 0 |
| 2 | 2.24[from 10log10(12/7)] |
| 4 | 4.77[from 10log10(12/4)] |
| 6 | 6.02[from 10log10(12/3)] |

TA ratio (ρ [dB]) of SL PTRS EPRE to PSSCH EPRE may be defined as in Table 10 below according to the number of PSSCH DM-RS antenna ports. Since up to 2 PSSCH DM-RS antenna ports are supported in an SL, and also up to 2 SL PTRS ports may be supported in an SL, it may be assumed that the number of PSSCH DM-RS antenna ports and the number of SL PTRS ports are the same. When the number of SL PTRS ports is 2, if a PTRS RE for one SL PTRS port is transmitted, a PTRS RE for the other SL PTRS port may be punctured, and instead, 3 dB power boosting may be performed as shown in Table 10.

TABLE 10

| The number of PSSCH layers with DM-RS | |
|---|---|
| associated to the PT-RS port | ρ [dB] |
| 1 | 0 |
| 2 | 3 |

Regardless of the number of PSSCH DM-RS antenna ports (e.g., the number of SL PTRS antenna ports) in Table 10, the ratio of SL PTRS EPRE to PSSCH EPRE may be assumed to be 0 dB.

Unlike Table 10, a case where an SL PTRS is transmitted in a symbol in which an SL PRS is transmitted is considered in Table 11 below. As described via FIG. 13 and FIG. 14, an SL PTRS may be transmitted in a symbol in which an SL PRS is transmitted. In this case, to maintain power of OFDM symbols the same, a ratio (p [dB]) of SL PTRS EPRE to PSSCH EPRE may be defined as illustrated in Table 11. As described above, no PSSCH may be transmitted in a symbol in which an SL PRS is transmitted. Therefore, when an SL PRS RE and an SL PTRS RE exist in the corresponding symbol, as a method of maintaining the same power as that of a symbol in which a PSSCH is transmitted, the ratio of EPRE may be defined by the equations illustrated in Table 11 below.

TABLE 11

| The number of | | | | |
|---|---|---|---|---|
| PSSCH layers | | | | |
| with DM-RS | | | | |
| associated to the | Comb size, N | | | |
| PT-RS port | 1 | 2 | 4 | 6 |
| 1 | 0 | 2.24[from | 4.77[from | 6.02[from |
| | | 101og10(12/7)] | 10log10(12/4)] | 10log10(12/3)] |
| 2 | 3 | 5.24 | 7.77 | 9.02 |

Regardless of the number of PSSCH DM-RS antenna ports (e.g., the number of SL PTRS antenna ports) in Table 11, the ratios of SL PTRS EPRE to PSSCH EPRE may be assumed to be only the values presented in Table 9.

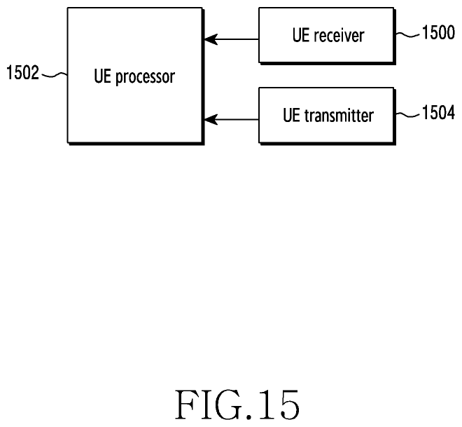

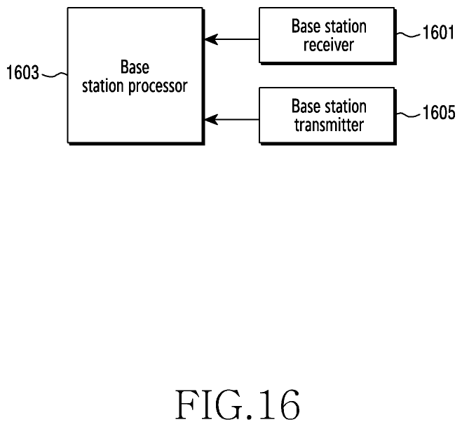

To perform the aforementioned embodiments of the disclosure, transmitters, receivers, and processors of a UE and a base station are illustrated in FIG. 15 and FIG. 16, respectively. A method for performing positioning by a UE in an SL is described, and to perform this, receivers, processors, or transmitters of a base station and a UE may operate according to the embodiments, respectively.

FIG. 15 illustrates an internal structure of a UE according to an embodiment.

Referring to FIG. 15, the UE may include a receiver 1500, a transmitter 1504, a processor 1502 (or controller), or a memory (not illustrated). In an embodiment of the disclosure, the receiver 1500 and the transmitter 1504 as a whole may be referred to as a transceiver. The transceiver of the UE may transmit/receive signals with the base station. The signals may include control information and data. To this end, the transceiver may include a radio frequency (RF) transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the UE processor 1502, and transmit signals output from the UE processor 1502 through the radio channel. The UE processor 1502 may control a series of processes such that the UE can operate according to the above-described embodiments.

FIG. 16 illustrates an internal structure of a base station according to an embodiment.

Referring to FIG. 16, the base station may include a receiver 1601, a transmitter 1605, a processor 1603 (or controller), or a memory (not illustrated). In an embodiment of the disclosure, the base station receiver 1601 and the base station transmitter 1605 as a whole may be referred to as a transceiver. The transceiver of the base station may be used to transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. In addition, the transceiver may receive signals through a radio channel, output the same to the base station processor 1603, and transmit signals output from the base station processor 1603 through the radio channel. The base station processor 1603 may control a series of processes such that the base station can operate according to the above-described embodiments.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure should be construed to include all changes or modifications derived from the meaning and scope of the claims and equivalents thereof.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A user equipment (UE) in a wireless communication system, the UE comprising:
a transceiver; and
a controller coupled to the transceiver, and configured to:
receive, from a base station, first information configuring sidelink positioning reference signal (SL PRS) resources in a shared resource pool,
receive, from the base station, second information configuring phase tracking reference signal (PTRS) resources, and
transmit, to the base station, a PTRS on a PTRS resource which is not overlapped with an SL PRS resource,
wherein the shared resource pool is for the SL PRS resources and physical sidelink shared channel (PSSCH) resources.

2. The UE of claim 1,
wherein the transmission of the PTRS is cancelled in a symbol associated with the SL PRS resource,
wherein a location of the PTRS resource is shifted next to a location of the SL PRS resource, and
wherein a location of the SL PRS resources configured by the first information is not overlapped with a location of the PTRS resources configured by the second information.

3. The UE of claim 1, wherein the controller is further configured to:
transmit, to the base station, an SL PRS on the SL PRS resource,
wherein the transmission of the SL PRS is cancelled in a symbol associated with the SL PTRS resource, and
wherein, in case that a Comb size of the SL PRS resources is equal to 2 or 4, a location of the SL PRS resources configured by the first information is not overlapped with a location of the PTRS resources configured by the second information.

4. The UE of claim 1,
wherein the transmission of the PTRS is based on a power boosting according to a number of antenna ports and a Comb size of the SL PRS resources, and
wherein a symbol level transmission power on the SL PRS resources and a symbol level transmission power on the PSSCH resources are identical.

5. A base station in a wireless communication system, the base station comprising:
a transceiver; and
a controller coupled to the transceiver, and configured to:
transmit, to a user equipment, UE, first information configuring sidelink positioning reference signal (SL PRS) resources in a shared resource pool,
transmit, to the UE, second information configuring phase tracking reference signal (PTRS) resources, and
receive, from the UE, a PTRS on a PTRS resource which is not overlapped with an SL PRS resource,
wherein the shared resource pool is for the SL PRS resources and physical sidelink shared channel (PSSCH) resources.

6. The base station of claim 5,
wherein a transmission of the PTRS is cancelled in a symbol associated with the SL PRS resource,
wherein a location of the PTRS resource is shifted next to a location of the SL PRS resource, and
wherein a location of the SL PRS resources configured by the first information is not overlapped with a location of the PTRS resources configured by the second information.

7. The base station of claim 5, wherein the controller is further configured to:
receive, from the UE, an SL PRS on the SL PRS resource,
wherein a transmission of the SL PRS is cancelled in a symbol associated with the SL PTRS resource, and
wherein, in case that a Comb size of the SL PRS resources is equal to 2 or 4, a location of the SL PRS resources configured by the first information is not overlapped with a location of the PTRS resources configured by the second information.

8. The base station of claim 5,
wherein the transmission of the PTRS is based on a power boosting according to a number of antenna ports and a Comb size of the SL PRS resources, and
wherein a symbol level transmission power on the SL PRS resources and a symbol level transmission power on the PSSCH resources are identical.

9. A method performed by a user equipment (UE) in a wireless communication system, the method comprising:
receiving, from a base station, first information configuring sidelink positioning reference signal (SL PRS) resources in a shared resource pool;
receiving, from the base station, second information configuring phase tracking reference signal (PTRS) resources; and
transmitting, to the base station, a PTRS on a PTRS resource which is not overlapped with an SL PRS resource,
wherein the shared resource pool is for the SL PRS resources and physical sidelink shared channel (PSSCH) resources.

10. The method of claim 9,
wherein the transmission of the PTRS is cancelled in a symbol associated with the SL PRS resource,
wherein a location of the PTRS resource is shifted next to a location of the SL PRS resource, and
wherein a location of the SL PRS resources configured by the first information is not overlapped with a location of the PTRS resources configured by the second information.

11. The method of claim 9, further comprising:
transmitting, to the base station, an SL PRS on the SL PRS resource,
wherein the transmission of the SL PRS is cancelled in a symbol associated with the SL PTRS resource, and
wherein, in case that a Comb size of the SL PRS resources is equal to 2 or 4, a location of the SL PRS resources configured by the first information is not overlapped with a location of the PTRS resources configured by the second information.

12. The method of claim 9,
wherein the transmission of the PTRS is based on a power boosting according to a number of antenna ports and a Comb size of the SL PRS resources, and
wherein a symbol level transmission power on the SL PRS resources and a symbol level transmission power on the PSSCH resources are identical.

13. A method performed by a base station in a wireless communication system, the method comprising:
transmitting, to a user equipment, UE, first information configuring sidelink positioning reference signal (SL PRS) resources in a shared resource pool;
transmitting, to the UE, second information configuring phase tracking reference signal (PTRS) resources; and
receiving, from the UE, a PTRS on a PTRS resource which is not overlapped with an SL PRS resource,
wherein the shared resource pool is for the SL PRS resources and physical sidelink shared channel (PSSCH) resources.

14. The method of claim 13,
wherein a transmission of the PTRS is cancelled in a symbol associated with the SL PRS resource,
wherein a location of the PTRS resource is shifted next to a location of the SL PRS resource, and
wherein a location of the SL PRS resources configured by the first information is not overlapped with a location of the PTRS resources configured by the second information.

15. The method of claim 13, further comprising:
receiving, from the UE, an SL PRS on the SL PRS resource,
wherein a transmission of the SL PRS is cancelled in a symbol associated with the SL PTRS resource, and
wherein, in case that a Comb size of the SL PRS resources is equal to 2 or 4, a location of the SL PRS resources configured by the first information is not overlapped with a location of the PTRS resources configured by the second information.

16. The method of claim 13,
wherein the transmission of the PTRS is based on a power boosting according to a number of antenna ports and a Comb size of the SL PRS resources, and
wherein a symbol level transmission power on the SL PRS resources and a symbol level transmission power on the PSSCH resources are identical.
